(19) United States
(12) Patent Application Publication
(10) Pub. No.: US 2018/0320784 A1
(43) Pub. Date: Nov. 8, 2018

(54) METHOD FOR POWER SHIFTING IN HYBRID AUTOMATIC TRANSMISSIONS BY MEANS OF A DUAL-CLUTCH STRATEGY INVOLVING TRANSFORMATION

(71) Applicant: IAV GmbH Ingenieurgesellschaft Auto und Verkehr, Berlin (DE)

(72) Inventors: Alexander LAMPE, Berlin (DE); Uwe METTIN, Berlin (DE)

(73) Assignee: IAV GmbH Ingenieurgesellschaft Auto und Verkehr, Berlin (DE)

(21) Appl. No.: 15/774,743

(22) PCT Filed: Nov. 24, 2016
(86) PCT No.: PCT/DE2016/100545

§ 371 Date: May 9, 2018

(30) Foreign Application Priority Data
Nov. 27, 2015 (DE) 10 2015 120 599.8
Nov. 27, 2015 (DE) 10 2015 120 601.3
Jun. 16, 2016 (DE) 10 2016 111 060.4

(51) Int. Cl. F16H 61/04; F16H 3/72; F16H 61/686; F16H 61/688; B60W 20/40; B60W 10/06

(52) U.S. Cl. CPC F16H 61/0437; F16H 3/724; F16H 61/686; F16H 61/688; F16D 2500/1085; B60W 10/06; F16H 2306/40; F16D 2500/7044; B60W 20/40

(57) ABSTRACT

A method for power shifting in hybrid automatic transmissions which can have any topology and are equipped with any number of additional drive units includes a generic transformation of the effective correlations between real transmission variables into virtual variables relating to a dual-clutch transmission such that a dual-clutch power shifting core having typical basic shifting modes can be used.

### DESCRIPTION

The invention relates to a method for load switching of automatic transmissions, especially of hybridized automatic transmissions, of arbitrary topology, which is characterized by a generic transformation of the effective relationships of real transmission variables to virtual variables of a dual-clutch transmission, so that a dual-clutch load-switching core with typical basic shifting modes can be used.

Automatic transmissions capable of load shifting in stages can be classified into two main types:

a) conventional automatic transmissions (AT, also referred to as torque-converter transmissions, hereinafter simply automatic transmissions), in which several planet gearsets are so disposed with different topologies that, by clutches and brakes, corresponding fixed gear ratios can be realized with an individual shifting logic, and

b) double-clutch transmissions (DCT, dual-clutch transmission), in which the drive torque is distributed with respectively one clutch to two parallel independent transmission input shafts or transmission drive shafts, which respectively realize odd or even gears with suitable gearwheel pairs for the output shaft.

Both transmission types can be hybridized, i.e. equipped with a further drive unit. This acts on a specific transmission element or on one or more power paths of the power-branched, hybridized automatic transmission and generates an additional drive torque. In an automatic transmission with one or more planet-gear sets and at least one electrical machine as further drive, an infinitely variable transmission ratio (electronic continuously variable transmission—eCVT) can then be achieved by virtue of the power branching.

The distinction between clutches and brakes in automatic transmissions rests on the different connection principles. Clutches connect two movable elements, for example two movable shafts, and brakes connect one movable element with one rigid element, for example a shaft with a housing. Since no substantial difference in terms of control or regulation systems results from this, both clutches, which are capable of connecting two shafts to rotate with one another, and also brakes, which are capable of connecting rotating components frictionally with a transmission housing, will be understood in the following as clutches in this connection (transmission context).

For starting, automatic transmissions are usually equipped with a hydrodynamic torque converter, which in some embodiments is replaced by a friction clutch. For shifting processes of the downstream transmission stages, the built-in starting element is indispensable.

Automatic transmissions as well as dual-clutch transmissions are capable of load switching, so that no interruption of the flow of force from transmission input to transmission output is permitted during gear shifting. Moreover, the shifting time is to be kept short and the output torque smooth, i.e. output-neutral. In the automatic transmission, however, in contrast to the dual-clutch transmission, the transmission input is not always because of the power branching decoupled from the transmission output during the shifting process and, in addition, the clutch torques are not included with an effective factor in the equation of motion.

All topologies of multi-speed automatic transmissions that do not correspond to a dual-clutch transmission with two independent sub-transmissions are included in the following in the automatic transmission type (AT). Hybrid transmissions mentioned above, in which one or more E-machines are integrated in a planetary transmission, are also included therein.

### Prior Art

German Laid-Open Application DE 10 2007 033 497 A1 relates to an automatic transmission with several frictionally engaging elements and a method for controlling such an automatic transmission, wherein especially the moment of inertia of the drive, which acts during a gear-shifting operation because of a change of the rotational state, is disengaged. For this purpose, the control unit is constructed in such a way that it controls a first and a second frictionally engaging element such that at least one first portion of a moment of inertia, which results from the gear-shafting process, is compensated, and that it controls a drive unit such that a second portion of the moment of inertia is compensated. The control unit may be designed such that it controls the first and the second frictional engagement element such that the moment of inertia is compensated with the exception of the second component, a maximum possible value of the second component of the moment of inertia is determined and then, when the maximum possible value is equal to a non-zero value, a distribution ratio smaller than unity and larger than zero is determined and the second component of the moment of inertia is determined by multiplying the moment of inertia with the distribution ratio. The document describes the shifting process of a four-speed automatic transmission by a process that comprises the shifting process of a dual-clutch transmission. However, neither is the non-trivial coupling of the transmission input and output by planet-gear sets taken into account nor are the necessary transformations considered. Starting from the task of DE 10 2007 033 497 A1, to accomplish a fast and smooth shifting process, the application of the equations of motion of a dual-clutch transmission to a four-speed automatic transmission is not sufficient, because the influence that the coupling between drive and output shaft has on the output torque of the AT during rpm transfer is not taken into account. In addition, the proposed calculation of clutch engagements for rpm shaping is applicable only for the non-accelerated vehicle state, which in dual-clutch transmissions is known to be almost zero for push upshifts with an output gradient. A generic shifting strategy for arbitrary automatic transmissions on the basis of proven methods for load acceptance and rpm transfer in arbitrary, typically highly dynamic vehicle states is thereby neither possible nor suggested.

German Laid-Open Application DE 10 2007 032 789 A1 describes a method for push downshifting of an automatic transmission, in which difference in speed of rotation between an input and an output side of a clutch and a distribution ratio of a total torque capacity at a first and a second clutch is defined and, from these two control variables, an integrated or composite control variable is generated. On the basis of these integrated control variables, it is possible to realize, for load acceptance and rpm transfer, a sequential shifting control unit that is applicable to a large number of automatic transmissions. This specific shifting control unit does not make it possible to transpose an existing shifting strategy to an arbitrary automatic transmission. Moreover, even here the non-trivial coupling of transmission input and output by planet-gear sets is not taken explicitly into consideration in equations of motion, and so the described shifting control unit forms merely a basis for shifting control units to be configured for each individual automatic transmission.

German Laid-Open Application DE 101 53 722 A1 discloses a method for shifting a load-switching transmission, in which an on-coming clutch unit assigned to the new gear is closed and an off-going clutch unit assigned to the old gear is opened in time-overlapping manner, wherein the clutch units are designed as continuously slip-regulated wet clutches, the closing of the on-coming clutch unit takes place approximately up to a working pressure corresponding to the clutch capacity of the off-going clutch unit and a filling completed with an end of filling, with an increased filling pressure corresponding to the order of magnitude of the clutch capacity of the off-going clutch unit, precedes the closing of the on-coming clutch unit. This process is also known as clutch precontrol.

German Patent Specification DE 100 14 879 B4 describes a method for control of a dual-clutch transmission with two input shafts, wherein a first friction clutch is assigned to the first input shaft and a second friction clutch to the second input shaft and a drive train can be respectively realized by means of each friction clutch, wherein, from the friction clutches, a drive torque of a drive unit is transmitted from the respective input shaft via the respective drive train to the output shaft, wherein the transmission has at least two gear stages, the first gear stage is formed at least by a first gearwheel pair and the second gear stage at least by a second gearwheel pair, and wherein the change of gear stage takes place by disengagement and/or engagement of at least one sliding sleeve that can be brought into engagement at least partly with the first or second gearwheel pair and wherein the rpm of the drive unit is changed in dependence on the gear stage to be engaged. The control complexity is simplified by the fact that the control of the rpm of the drive unit takes place during the change of gear stage by means of at least one of the two friction clutches. Except for the push upshift, the rpm control of the drive unit usually takes place by the control unit of the drive unit. This simplifies the shifting control of a dual-clutch transmission to the effect that precisely no compensation engagement, by clamping of the friction clutches as described in DE 100 14 879 B4, is needed.

German Patent Specification DE 196 39 376 C1 relates to an automatically controlled clutch in the drive train of a motor vehicle. In the closed state, the clutch operates with extra contact pressure, so that the torque that can be transmitted by the clutch is greater by a predetermined amount than the torque generated by the engine. At low outside temperatures, the proportion of extra contact pressure is reduced, in order to shorten the travel of the clutch and to reduce the energy demand during the clutch actuation. Thereby a sluggishness of an actuating aggregate that increases at low temperatures can be compensated for clutch actuation. This special configuration of a generally known extra-contact-pressure control relates to one clutch. A scaling to several clutches is not disclosed.

European Patent EP 1 497 576 B1 describes a control method for automatic transmissions that is based on a drive-train model that describes the conditions relevant to control of a shifting process in generalized manner. For execution of the shifting process in the automatic transmission, which is designed for transmission of a torque between two inertia components at various transmission ratios, the following steps are provided, wherein the inertia components represent at least one drive unit or one load and the transmission comprises a drive shaft and an output shaft with a first force-transmission path and a second force-transmission path provided in between, wherein the force-transmission paths are provided with a direct clutch having an adjustable torque-transmission power T_{H} or an indirect clutch having an adjustable torque-transmission power T_{L}. A gearset input torque Tᵢₙ is determined that is to be transmitted by the transmission in the direction from the drive shaft to the output shaft. The torque-transmission powers T_{H} and I_{L} are controlled in dependence on the gearset input torque Tᵢₙ to be transmitted in such a way that a) when Tᵢₙ>0, then T_{H}=Tᵢₙ and T_{L}=0 or b) when Tᵢₙ<0, then T_{H}=0 and T_{L}=Tᵢₙ. It is shown by a simplified model that the torque transmission can be configured by a function of the transmission ratio in dependence on the time. However, the rpm transfer is perceptibly uncompensated at the output.

German Laid-Open Application DE 101 38 998 A1 relates to a device and a method for control of a shifting sequence in a transmission capable of load switching in a motor vehicle. In order to ensure a comfortable operation of the transmission capable of load shifting, it is provided that an rpm of the transmission input shaft and a torque on the transmission output shaft are adjustable by means of the device. According to the corresponding method, it is provided that, in a first phase, the torque on the transmission output shaft is adjusted to a first torque target value and, in a second phase, the rpm of the transmission input shaft is adjusted to an rpm target value and simultaneously the torque of the transmission output shaft is adjusted to a second torque target value. In this connection, both clutches, which are capable of connecting two shafts to rotate with one another, and also brakes, which are capable of connecting rotating components frictionally with a transmission housing, will be understood as clutches.

European Patent Specification EP 1 108 164 B4 describes a method for control and regulation of the clutch during three driving states, wherein exclusively one single regulation circuit is used. The regulation variable corresponds to the actual value of the differential rpm of the clutch. These three driving states correspond to a starting process as the first state, to the driving with constant gear ratio as the second state and to a third state, which exists when either a load switching or a positioning of the gear ratio from a first into a second gear-ratio stage of an automatic transmission is initiated, wherein the load switching is used in a multi-speed transmission capable of automatic load switching and the positioning of the gear ratio is used in an automatic multi-speed transmission with traction-force interruption during shifting for a motor vehicle. During load switching in the sense of an overlapping shifting, a regulation circuit of its own, referred to hereinafter as second regulation circuit, determines the behavior of the engaging and disengaging clutches. It is proposed that the first and second regulation circuits be connected to one another via a decoupling network, wherein the decoupling network has a first and second signal path. Via the decoupling network, therefore, the advantage is achieved that the two regulators do not mutually influence one another in their action.

German Laid-Open Application DE 10 2008 008 460 A1 relates to a method for control of the clutches of a dual-clutch transmission during a gear change from a current gear to a target gear, in which a torque transfer from the load-delivering (off-going) clutch to the load-accepting (on-coming) clutch takes place during the gear change, containing the steps: Increase of the transmittable torque of the on-coming clutch up to the instantaneous drive torque; relaxation of the transmittable torque of the off-going clutch; wherein, during the gear change, the summation torque comprising the transmitted torques of the off-going clutch and of the on-coming clutch is larger at least temporarily than the instantaneous drive torque and in the process the on-coming clutch has a higher transmittable torque than corresponds to a limiting torque, at which the torque of the on-coming clutch is uniformly increased from the initial state of the torque transfer to a final state of torque transfer.

The non-prepublished German Patent Application DE 10 2015 120 599.8 discloses a method for load switching of automatic transmissions by a dual-clutch strategy with transformation, the entire content of which is explicitly incorporated in the present disclosure.

International Application WO 2009/024162 Al discloses a hybrid drive system with a first drive machine, especially an internal combustion engine, and two further drive machines, especially two electric motors, for a motor vehicle. It comprises two gear-shifting sub-transmissions, each with one input shaft and one output shaft, wherein the first drive machine, the first input shaft and the second input shaft are respectively in driving connection with the members of a planetary transmission and the further drive machines are respectively in rigid driving connection with one of the input shafts. A favorable assignment of the three drive machines to the members of the planetary transmission lies in the fact that the first drive machine is rigidly coupled with the planet carrier, the first further drive machine with the ring gear and the second further drive machine with the sun gear of the planetary transmission. In order to exhaust the possibility of the transmission arrangement with low energy expense, it is provided that locking brakes are provided for the members of planet-carrier gear connected to the input shafts, especially for the ring gear and the sun gear. Instead of the said locking brakes, the further drive machines themselves may also be used for generation of a holding torque for the corresponding members of the planetary transmission. By a logical sequence of opening and closing of the two locking brakes on the two input shafts as well as of energization and de-energization of the two further drive machines as well as a sequence, adapted thereto, of the actuation of the shifting units of the various gears, a traction-force-free shifting between the gears is possible.

### Task of the Invention

The task of the present invention is to specify a method for output-neutral load switching of hybridized automatic transmissions of arbitrary topology, in which proven methods can be used for load acceptance and rpm transfer of dual-clutch transmissions.

### Disclosure of the Invention

The task is accomplished by a method for load switching of hybrid automatic transmissions (AT) with an arbitrary number of gear stages and a number n of clutches and with a first of p drive units and at least one further of p drive units on the basis of a generic transformation of real transmission variables of the hybridized automatic transmission to virtual variables of a dual-clutch transmission (DCT) with associated dual-clutch-transmission-specific basic shifting modes corresponding to the independent claim 1.

The first of p drive units is preferably an internal combustion engine. The at least one further of the p drive machines is preferably an electric machine (E machine), for example a synchronous or asynchronous machine. The use of an E-machine advantageously permits the saving of actuating energy for gear changes or the elimination or at least the relaxation of actuating-variable limitations of the automatic transmission. Furthermore, it is possible thereby to use claw clutches instead of friction clutches, at least on some power paths, which further increases the overall efficiency of the transmission.

The method according to the invention consists in that important strategy variables for the DCT power-shifting core are supplied by a forward transformation and actual actuating variables with corresponding effective factors for the hybridized automatic transmission are generated by a back-transformation, including a torque control of the at least one further drive unit and an extra-contact-pressure control of all relevant clutches. This DCT power-shifting core is the shifting logic, shifting-sequence control unit or transmission control unit that controls the gear changes according to a basic shifting mode. The load-switching core of a dual-clutch transmission has at least one, preferably several basic shifting modes capable of load switching. They include a pull upshift, a pull downshift, a push upshift and a push downshift. The distinction between pull and push is that the drive torque is by definition positive under pull and by definition negative under push. A positive drive torque in this sense means that a drive unit delivers a drive torque to the drive wheels, whereas in push a braking torque, also referred to as drag torque, is transmitted from the drive wheels to the drive unit. Where a DCT load-switching core is mentioned in the following, it means a shifting logic, corresponding to one or more basic shifting modes, that takes place on a corresponding control device.

A load switching is subdivided into at least two main phases, the load-acceptance phase and the rpm-transfer phase, wherein the sequence depends on the shifting type, i.e. on the basic shifting mode to be used. During the rpm-transfer phase, at least one engagement by a drive unit and/or a clutch takes place, in order to transfer the rpm. In order to configure this rpm transfer to be output-neutral, i.e. by holding the output torque or the output gradient constant, an additional compensating engagement of at least one clutch and/or of the at least one further drive unit takes place, which compensates for a feedback torque, if one exists, caused by a coupling between input and output.

The transformations are generic, and so the AT topology and the number of shifting stages can be arbitrarily complex. In this connection, the actually existing, i.e. real transmission variables of the hybridized automatic transmission are transformed, i.e. converted mathematically into virtual variables, i.e. only for the variables existing for the necessary calculations of the load switching.

A principle of on-coming, off-going and maintained clutches is applied, wherein the at least one further drive unit is likewise subjected, as a torque source equivalent to a clutch, to the on-coming, off-going and maintained principle, because from the mechanical viewpoint the further drive unit. e.g. E-machine, just as a clutch, can be represented as a torque source. Positive and negative torques can be imposed with the E-machine, whereas the effective direction of a clutch torque is determined solely by the clutch slip. From the viewpoint of control technology, the E-machine may therefore be treated as a clutch, wherein the restriction pertaining to the effective direction is removed.

On-coming clutches are load-accepting clutches, which are opened prior to the gear change and closed after the gear change, i.e. no torque is transmitted prior to the gear change and a torque of magnitude usually greater than zero is transmitted after the gear change. Off-going clutches are correspondingly load-delivering clutches, which are closed prior to the gear change and opened after it. On-coming and off-going clutches are involved directly in the shifting process (active clutches). Maintained clutches are all clutches that are closed or remain closed during a shifting process. Even during a shifting process, these transmit a torque from the input to the output or vice versa. However, their status does not change during a shifting process, because they are not directly involved in the shifting process (non-active clutches). In principle, clutches that remain open may also be regarded as maintained clutches. For reasons of clarity and unambiguousness, clutches that remain open, i.e. clutches that are opened or not in engagement prior to and after the shifting process, will be referred to as open clutches. A clutch qualifies as open even if it exhibits an rpm difference between input and output side of the friction element (so-called slip) or the set clutch capacity is smaller than the torque to be transmitted quantitatively effectively (cutting torque) in the case of a frictional coupling of the input and output side of the friction element. The off-going clutch would therefore be an open clutch as soon as it reaches the slip condition at the beginning of an rpm-transfer or load-accepting phase. For reasons of clarity, however, this clutch will be referred to as an off-going clutch until the complete end of the gear change. An exception may exist if a new gear request, e.g. during abort of shifting, is present during the gear change. In general, open clutches are not involved in the shifting process (non-active clutches). Since the clutch actuation usually takes place hydraulically and a defined engagement is possible only when the actuating cylinders are pressurized and filled with sufficient hydraulic pressure, open clutches in which this is not the case cannot be actuated without certain lead time. However, a situation may exist in which the clutch is open at the beginning and at the end of the shifting process and is brought into engagement during the shifting process. As mentioned above, this requires a certain lead time. In known topologies of automatic transmissions, at least one and often several open clutches exists or exist in each individual gear-change process. Therefore at least one clutch will be the term used in the following. In this connection, the possibility that no open clutch will be encountered during a gear-change process will be explicitly included, because this possibility is covered by the method according to the invention, even though it is encountered rather seldom in practice.

Several modes of operation can be represented with a hybrid automatic transmission, e.g. electric driving, internal-combustion-engine driving and hybrid driving. These are achieved in so-called parallel hybrid vehicles by usually fixed gear-ratio stages of the transmission. Besides the said modes of operation, further sub-modes of these can be represented, for example in the form of mild hybrid vehicles, as long as at least two drive units are present. The start-stop-system mode of operation should be explicitly mentioned, in which the one drive unit, preferably the internal combustion engine, is automatically stopped and restarted in suitable operating situations. In this connection, a start-stop system abstractly comprises the sub-modes of operation of engine off (drive-unit rpm zero) and engine on (drive-unit rpm greater than or equal to the idling rpm), which are to be transferred into one another.

With appropriate interconnection of the transmission components by clutches or brakes, an electronically controlled positionable continuous transmission gear ratio (eCVT—electronic continuously variable transmission, also referred to as simply CVT) may be implemented alternatively or additionally to the aforesaid modes of operation. Depending on mode of operation, this further drive unit applies a drive torque or a holding torque on a power path of the power-branched hybridized automatic transmission. Beyond this, modes of operation exist in which power is drawn from the automatic transmission and stored in other energy forms (e.g. electrical energy via a generator) or dissipated to the environment (e.g. thermal energy). Finally, modes of operation exist in which the further drive unit is decoupled completely from the power flow. A defined power flow in the automatic transmission, which can be distinguished from the other modes of operation, is common to all modes of operation. Upon each change of mode of operation, i.e. upon a displacement of the power flow within the power-branched automatic transmission, in which further transmission elements such as clutches and brakes may also be involved, in principle the same steps are executed as in a conventional gear-change process, namely a load transfer and an rpm adaptation. These may also take place in parallel or simultaneously in certain changes of modes of operation. From the viewpoint of the gear-change or transmission control, the change of a mode of operation of the hybridized automatic transmission can be executed with the same control commands as a conventional load-switching process. Hereinafter, therefore, the change of the mode of operation will also be explicitly understood under load-switching process or shifting or gear-change process.

The extra-contact-pressure control of the relevant clutches already alluded to is exercised on the basis of cutting torques and takes place preferably for all clutches that remain closed. Nevertheless, off-going clutches may be subjected precisely to an extra-contact-pressure control at the beginning of the shifting process, just as may on-coming clutches at the end of the shifting process.

Proven shifting strategies, i.e. the basic shifting modes of a dual-clutch transmission, are saved in a DCT load-switching core and, during a shifting process of a hybridized automatic transmission, are used for load acceptance and rpm transfer in all driving situations, such as upshifting, downshifting, respectively of pull or push type, changes of mode of operation as well as for abort of shifting. The basic shifting modes in the DCT load-switching core are subject to the application of the switching processes of the AT without the need for the applier to know the topology or the modes of operation of the hybridized automatic transmission. In this connection, scaling takes place of the clutch torques to be transmitted corresponding to the DCT shifting strategy for the actuators of the automatic transmission, including the further drive unit. The shifting-sequence control corresponding to the DCT strategy is used for realization of all direct shifting modes of the AT shifting logic.

Although this is known to the person skilled in the art, it will be remarked that, whenever moment is mentioned in the following, torque is meant, with one exception. The exception relates to mass moments of inertia, which are not torques but instead are a geometric and material-specific property of moving masses, such as shafts and gearwheels. Mass moments of inertia are known from the field of industrial mechanics and may also be referred to merely as inertias, which certainly is physically imprecise but in the present disclosure is equated with mass moment of inertia.

The method according to the invention for load switching is started by the initiation of a shifting process for a gear-change pair (i, j) from a gear i with an actual gear ratio (yᵢ) to a gear j with a target gear ratio (yᵢ) and the accompanying rpm transfer of the primary drive unit, preferably the crankshaft of the internal combustion engine or the transmission input shaft, in dependence on a target gear preselection derived preferably from a driver's request. Every change of mode of operation may also be characterized or determined by a gear-change pair with an actual and a target gear ratio or an actual and a target gear. For example, during the change to a mode of operation with continuously variable transmission, it is possible to start from an actual gear having a (fixed) actual gear ratio, which is shifted to a target gear with strategically variable target gear ratio. The strategic variability can be saved as additional or separate control in the DCT load-switching core or preferably implemented independently of the shifting process and thus of the DCT load-switching core of the control device of the hybridized automatic transmission. In the process of shifting into the variable gear, the gear ratio of the last fixed gear to be engaged would be the initial or starting gear ratio of the variable gear. Start-stop, likewise referred to here as change of mode of operation, can likewise be represented with the variable gear ratio, because an arbitrary gear ratio and thus also an rpm of zero can be adjusted for the (first) drive unit. In this connection, start-stop, i.e. the change between engine on and engine off, can be interpreted as rpm transfer and implemented in output-neutral manner by the control unit, wherein the relative torque of the (first) drive unit to be compensated by the E-machine corresponds to the drag torque of the engine and the basic torque of the (first) drive unit is zero (engine start-stop stationary). Shifting processes in automatically shifting transmissions, as find use in motor vehicles, for example, are usually initiated by a drive via the power or dynamic requirements, also known as driver's request, or a vehicle control system, likewise referred to in the following for clarity as driver's request. From this, a target gear preselection is derived. Changes of modes of operation are usually initiated by a corresponding control-device program, known as hybrid manager, which among other features optimizes the current efficiencies of the individual drive units as well as their interaction, also by selective operating-point displacement. In this connection, further boundary conditions can be introduced into the initiation of the shifting process, such as torque-related load requirements or economic criteria. The initiation of a shifting process is known in itself and may be determined or brought about by the transmission-control or engine-control device or any other suitable control device. The shifting process is characterized by a change from a gear i (actual gear) to a gear j (target gear). Both gears exhibit a different transmission ratio between the rpm of the drive shaft or of the transmission input shaft and the rpm of the output shaft or the transmission output shaft and do not have to be sequentially shifted. This means that, for example, it is possible to shift directly from the 1st gear into the 3rd gear. As already described, a CVT mode, i.e. a transmission ratio that is infinitely variable within certain limits, can also be represented from the viewpoint of gear-change control or transmission control as a gear with a defined transmission ratio, wherein the latter can be expressed not by a constant but instead by a relationship subjected to an assignment rule, e.g. a functional relationship. If the infinitely variable transmission ratio is controlled electronically, for example by means of an E-machine, it is also described as eCVT mode or eCVT gear.

Once the shifting process has been initiated, the sensing of actual variables of the hybridized automatic transmission and of the first drive unit and/or of the at least one further drive unit takes place in the next step or preferably constantly for execution of the method for load switching of the automatic transmission. The actual variables are parameters of the vehicle and of the transmission that describe the current actual state of the vehicle and of the transmission, and are measured, calculated or sensed in some other way. The actual variables comprise at least one or preferably several and particularly preferably all of the following variables.
a drive or input shaft rpm (ωᵢₙ) at least of one drive or input shaft of the hybridized automatic transmission, wherein the torque input of the first drive unit as well as the transmission element to which a torque of the at least one further drive unit can be delivered is applicable as drive shaft (in this connection, ωᵢₙ is to be understood as a vector variable, the individual vector elements of which are the input or drive shaft rpm (from the transmission viewpoint) of the p drive units (e.g. ω_{VKM}) and which are gear-change-pair-dependent clutch-input rpms ωᵢₙ ^{(i,j)}, that are likewise to be understood as a vector),
an output shaft rpm (ωₒᵤₜ) of an output shaft of the hybridized automatic transmission (the vector representation of the drive shaft rpm ωᵢₙ is applicable by analogy for ωₒᵤₜ),
a drive torque made available by the first drive unit and present at the drive shaft of the hybrid automatic transmission (Tᵢₙ-in vector form in the case of several drive shafts, e.g. on the basis of several drive units; for better distinction, an unambiguous index assignment is used whenever necessary for each drive unit in the following, for example T_{VKM} for the first drive unit (internal combustion engine, T_{EM} for the at least one further drive unit (E-machine), with further indexing in the case of more than one further drive units),
currently set clutch capacities (T_{cap}) of the n clutches and/or
a minimally and/or maximally available drive torque (T_{in,min}, T_{in,max}) of the first and/or also of the at least one further drive unit. The available drive torque is respectively dependent on the state of the drive units, which can be characterized by further parameters, such as their rpms and set load requirements, for example, as well as by the effective direction of the imposed drive torque. Thus a braking torque capable of being maximally imposed by a further drive unit, e.g. an E-machine, may be quantitatively smaller than a drive torque.

It must be remarked that all variables used with or without a countable whole-number index can be understood in vector form, wherein the index determines the respective vector element. The mathematically correct notation of the vector variables is defined on the example of the currently set capacities (T_{cap,k}) with the index k and k=1, 2, . . . , n for n clutches in total, and specifically as

$${T}_{cap} = [ \begin{matrix}{T}_{cap , 1} \\ {T}_{cap , 2} \\ ⋮ \\ {T}_{cap , n}\end{matrix} ] .$$

For reasons of clarity, the vector representation as well as the attachment of the countable whole-number index will be largely avoided. One exception is the indices i and j, which denote the current and the next gear, i.e. the actual gear i and the target gear j and always designate only one element respectively of the index set “arbitrary number of gear stages”. Further exceptions will be explicitly explained as needed at the appropriate places. If the countable index is omitted, the emphasis lies not on the individual element of the index set but instead on the vector variable in itself. The person skilled in the art reads the vector as such and recognizes whether or not a specific element is meant. The following indices are used within the scope of the present disclosure:
i Actual gear
j Target gear
n All clutches and brakes built into the transmission
m All clutches and brakes remaining closed, i.e. in engagement, during a shifting process
p All drive units acting directly or indirectly on the transmission
in/out Input and output variables from the viewpoint of the transmission
kom/geh Emphasis on the vector elements that are assigned to the on-coming and off-going clutches
nom Nominal variable for the actual precontrol without relative engagements for a smooth load acceptance and rpm transfer
min/max lower and upper values available for forces, torques or capacities.

Beyond this, it is remarked for completeness that the method according to the invention can also be used for a dual-clutch transmission, wherein the transformation will be simplified in principle in this case, because some intermediate steps are trivial.

The clutch capacity is the actual actuating variable of a clutch and indicates the magnitude of a corresponding torque that is to be transmitted or that can be transmitted independently of effective direction. Clutch capacities are precontrolled during a shifting process, i.e. are adjusted according to a quantitative preselection, and are maintained until a change of control is necessary, e.g. on the basis of a pending shifting process. The same applies from the viewpoint of the transmission control for the torque delivered by the at least one further drive unit, the effective-direction-independent magnitude of which, just as the clutch capacity, is precontrolled as the actuating variable. For precontrol, the physical relationships of the clutch capacities and of the hydraulic pressures of the actuating cylinders, their actuating positions and ultimately also their electrical currents for activation of the directional control valves must be known and saved as the actual actuating variable. For the precontrol of the at least one further drive unit, its effective principles must be known and under control, e.g. the relationship between activating current and delivered torque of an E-machine or the relationship between air or fuel supply of a further internal combustion engine and its delivered torque. The person skilled in the art of transmission engineering knows these relationships and applies them. The precontrol of the clutch capacity and of the torque delivered by the at least one further drive unit naturally takes place even outside a shifting process, in the so-called fixed gear, and does so for all closed clutches and further drive units integrated in the power flow. Stated more precisely, the magnitude of the precontrolled clutch capacities of the clutches closed in the fixed gear or the magnitude of the torque of the at least one further drive unit is greater than zero. This special case, in which the actual gear i corresponds identically to the target gear j, is relevant for the existing load-switching method only to the extent that the clutches remain closed in controlled manner by an additional extra-contact-pressure control and the at least one further drive unit applies a necessary holding or supporting torque for a fixed or infinitely variable transmission ratio.

The actual variables are generally sensed regularly or constantly by corresponding detection means, e.g. by means of sensors, or are calculated and communicated to a transmission control device or a control device of the drive unit and used precisely for shifting processes of the control or regulation of the load acceptance and rpm transfer. Finally, it must be remarked that it is possible to superpose a precontrol by a regulating circuit, which is able to cancel out disturbance variables that may be present. The more precisely the precontrol takes place, the smaller is the deviation of the precontrol variable from the variable to be actually set in the real situation and thus the disturbance variable to be canceled out. The latter can be determined online by known estimation and identification methods, also referred to as observers.

In order now to execute the shifting process of the hybrid automatic transmission on the basis of a basic shifting mode of a dual-clutch transmission, the selection of at least one transformation factor is carried out in the next step in dependence on at least one actual variable and the gear-change pair (i, j) from tables of states. Tables of states may exist in the form of lookup tables, performance characteristics or similar and saved in a memory, which can be accessed by the transmission control device.

In some embodiments, the selection of the transformation factors may comprise the selection of coefficients (a^{(i,j)}) determining the automatic-transmission topology in dependence on the gear-change pair (i, j) from a table of states. These coefficients describe the hybridized automatic transmission in terms of the specific gear ratios of the individual gear stages or of the functional relationships of the infinitely variable gear ratio of a CVT gear as well as the specific arrangements of the clutches on the basis of automatic-transmission-specific constants specific, and they reappear in transmission or precontrol equations that are known in themselves. The coefficients (aₒᵤₜ^{(i,j)}, aᵢₙ^{(i,j)}), which are referred to as coupling components, which map the topologically imposed feedback effects or reaction in a coupling between input and output during a gear change, form a subset of the coefficients (a^{(i,j)}).

In some embodiments, the selection of the transformation factors may comprise the selection of effective factors (b^{(i,j)}) of clutch capacities (T_{cap}), to be set, of the n clutches and of a drive torque (T_{EM}) delivered by one of the at least one further drive units in dependence on the gear-change pair (i, j) from a table of states. In automatic transmissions, corresponding tables of states, which determine for each fixed gear whether its status should be open or closed, are obtained due to the large number of clutches/brakes. If it is assumed that one clutch opens and another closes during a gear change, an analogy to shifting processes in dual-clutch transmissions is obtained. The representation of this analogy takes place by the effective factors, which scale the n clutches of the automatic transmission to the two clutches of the dual-clutch transmission and vice versa. Depending on gear-change pair, each clutch may shift, in the transmission, different power paths, which have different transmission ratios. Beyond this, the drive torque of the first drive unit as well as of the at least one further drive unit is distributed among different power paths as a result of the existing power branching. For each gear-change pair, it is possible to define (design-related) clutch-specific coefficients, mode-of-operation-dependent coefficients of the (further) drive units and coefficients for the transmission drive and output sides, which represent the respective transmission-internal transmission ratios and inertia ratios. The effective factors are determined from these. The effective factors are changed over in the case of gear-change request, i.e. when actual and target gear are not identical. They are maintained until a new pair requests a changeover. The effective factors can generally be determined from the coefficients (a^{(i,j)}). If no CVT gear exists, the effective factors are automatic-transmission-specific constants specific. It is therefore more advantageous to select these directly and not to determine them freshly for each gear-change process. If a CVT gear exists, it may likewise be advantageous to select the effective factors directly, because in this way computing capacity can be saved, depending on configuration.

Furthermore, in some embodiments, the selection of the transformation factors may comprise the indexing (idx^{(i,j)}) of the none or at least on on-coming (idxₖₒₘ^{(i,j)}) and of the none or at least one off-going (idx_{geh}^{(i,j)}) clutch and of the none or at least one clutch that remains closed (idx_{blb}^{(i,j)}) of the n clutches and of the status (idx_{Em}^{(i,j)}) of the at least one further drive unit in dependence on the gear-change pair (i, j) and/or on the selected mode of operation from a table of states, i.e. the assignment of the respective clutch to the respective index. On-coming clutches are characterized in that they are open in gear i and closed in gear j. During the shifting process, these must be appropriately closed. Off-going clutches are opened in the course of the shifting process, i.e. taken out of engagement. At least one on-coming and at least one off-going clutch always exist during every shifting process, wherein the at least one on-coming or the at least one off-going clutch can be replaced by the at least one further drive unit. Maintained clutches remain closed. Accordingly, this power branch continues to transmit a torque, in which case, depending on the gear-change pair and the number of gear-change pairs, it is possible that none, one or several clutches remain closed. The at least one further drive unit may also replace a maintained clutch. The remaining clutches are open, which may also be the case for the at least one further drive unit and which then means that it exerts no influence on the power flow, e.g. because its power path is not active for the existing gear-change pair, or a torque of zero is imposed or torque is completely decoupled from the power flow. Accordingly, the status (idx_{EM}^{(i,j)}) of the at least one further drive unit corresponds to that of an on-coming or an off-going clutch or of a clutch that remains closed or remains open. In practice, this means that the status of the at least one further drive unit is incorporated in the indices of the on-coming, off-going and maintained clutches, wherein the at least one further drive unit is regarded as a torque source equivalent to a clutch and is included as a further tuple in the respective index vector. Closed and open clutches retain their status respectively in gear i and gear j, but may be brought temporarily into or out of engagement during the gear change. The indices of the on-coming and off-going clutches and of clutches that remain closed, and the status (idx_{Em}^{(i,j)}) of the at least one further drive unit, are changed over in the case of gear-change request, i.e. when actual and target gear are not identical. They are maintained until a new gear-change pair requests a changeover.

In some embodiments, the selection of the transformation factors comprises the selection of a gear-change-pair-dependent drive mass moment of inertia (Jᵢₙ^{(i,j)}) of the hybridized automatic transmission and of a gear-change-pair-dependent output mass moment of inertia (Jₒᵤₜ^{(i,j)}), dependent on gear-change pair (i, j), of the hybridized automatic transmission from a table of states. The gear-change-pair-dependent drive and output mass moments of inertia of the automatic transmission are needed for the calculation of a drive mass moment of inertia (Jᵢₙ^{(DCT)}) equivalent to the gear-change-pair-independent drive mass moment of inertia, of the dual-clutch transmission, wherein the latter can be determined from the coefficients (a^{(i,j)}), preferably the coupling coefficients (aₒᵤₜ^{(i,j)}, aᵢₙ^{(i,j)}) and the gear-change-pair-dependent drive and output mass moments of inertia (Hᵢₙ^{(i,j)}, Jₒᵤₜ^{(i,j)}) as well as an rpm ratio (ψₒᵤₜ/ωᵢₙ) of the output-shaft rpm (ωₒᵤₜ) and of the drive-shaft rpm (ωᵢₙ). The determination may require less determination resources when an intermediate variable (Jᵢₙ^{(i,j)}is derived from the gear-change-pair-dependent drive mass moment of inertia and the coupling coefficients. The equivalent drive mass moment of inertia is then determined or derived in dependence on the intermediate variable, the gear-change-dependent output mass moment of inertia as well as the rpm ratio and the coupling coefficients. In a dual-clutch transmission, two parallel sub-transmissions are present, the moving masses of which and thus their mass moments of inertia respectively remain constant in principle. For example, the output mass moment of inertia in dual-clutch transmissions may fluctuate on the basis of the cargo of the vehicle. However, this is a value that is constant or slowly variable during a journey, is taken into consideration by the sensing of the actual variables and in any case is not influenced by the shifting process. In automatic transmissions, the power paths within a transmission topology vary according to the engaged gear. Thus the moving transmission elements and therefore the mass moments of inertia differ according to gear-change pair (i, j). A variable mass moment of inertia must now be supplied to the load-switching core of the dual-clutch transmission, which actually expects a constant drive mass moment of inertia. On the one hand, the moments of inertia of the automatic transmission that vary in dependence on gear-change pair must then be taken into consideration, and on the other hand the output-coupling-related feedback between output and drive, namely the so-called output-coupling-related disturbance torque, which in turn acts on the drive in proportion to the output-shaft rpm gradient. A correction or a compensation is applied via the drive mass moment of inertia (Jᵢₙ^{(DCT)}) equivalent to the gear-change-pair-independent drive mass moment of inertia, in order to be able to apply the basic shifting mode of the load-switching core.

In some embodiments, the selection of the transformation factors comprises the selection of coefficients (c^{(i,j)}) for determination of cutting torques (T_{cut,blb}) for the m clutches that remain closed and for determination of a holding torque (T_{cut,EM}) of the at least one further drive units in dependence on the gear-change pair from a table of states. Cutting torques are the torques, actually being transmitted currently, of the clutches that remain closed. These are determined at the free cut (therefore cutting torque) of the respective clutch via a torque equilibrium of all total capacities and free actuating variables. Their effective directions are obtained in dependence on the gear-change pair (i, j) of the drive-shaft rpm ( 7 ᵢₙ) and of the output-shaft rpm (ωₒᵤₜ) In principle, the effective direction of the at least one further drive unit does not have to be determined or calculated, since it is able to act in controlled manner in both directions. Because the torque delivery is variable within system-related limits, a holding torque (T_{cut,EM}) corresponding to the current requirements can also be delivered by the at least one further drive unit. In contrast, the determination of the holding torque (T_{cut,EM}) takes place by analogy with the determination of the cutting torques of the clutches that remain closed, which is also reflected in the indices used in the formula symbols for cutting and holding torque. The occurring cutting and holding torques can be calculated on the basis of known actuating variables of the drive, i.e. drive torque (Tᵢₙ) or alternatively drive gradient (ωᵢₙ) of the first and/or of the at least one further drive unit, actuating variables of the at least one off-going, on-coming and possibly open clutches (T_{cap}) or of the at least one further drive unit (T_{EM}) as well as measured variables of the output, i.e. output gradient(ωₒᵤₜ) or alternatively output torque (Tₒᵤₜ).

In some embodiments, the selection of the transformation factors may alternatively or additionally comprise the selection of maximum transmittable clutch capacities (T_{cap,max}) of the n clutches in dependence at least on one actual variable, for example the currently set clutch capacities of the n clutches and/or on the minimally and/or maximally available drive torque of the first and of the at least one further drive unit. The DCT load-switching core (not hybridized) controls the clutch torques or clutch capacities on the basis of the drive torque to be transmitted or requested. However, because of the effective factors, which may be larger than equal to or smaller than unity and even negative, the capacity actually to be set for the clutches may be lower or higher than the DCT load-switching core assumes. Beyond this, the load-switching core does not recognize any further drive units. Therefore the maximally transmittable clutch capacities and the drive torque to be maximally transmitted must be selected on the basis of the effective factors, mathematically converted into maximally settable DCT clutch capacities and communicated to the load-switching core. These maximally transmittable clutch capacities are determined from the clutch properties and characteristic values. The quantitatively maximally transmittable drive torque of the further drive unit is determined not only from the properties and characteristic values of the drive unit but also from already imposed holding and supporting torques as well as drive torques and their effective directions, among other information.

A further step of the method according to the invention comprises the calculation of at least one transformation equivalent for the calculation of at least one dual-clutch-transmission-specific actuating quantity by the basic shifting mode of the dual-clutch transmission in dependence on at least one actual variable and/or the at least one transformation factor. The transformation equivalents are mathematically converted state variables, also referred to as (state) quantities, which the DCT load-switching core or the basic shifting mode needs in order to determine actuating variables, also known as actuating quantities, for a gear change in conformity with the requirements, such as freedom from traction-force interruption and smooth load acceptance as well as rpm transfer. In a normal dual-clutch transmission, these state variables would correspond to the above-defined actual variables (or the actuating variables that currently exist and have been mathematically converted to the clutches). Here, however, the actual variables have been sensed for a hybridized automatic transmission. They must therefore be mathematically converted to transformation equivalents in dependence preferably on several actual variables and/or preferably several transformation factors. As quantities, variables are designated that characterize the current or future intended state of the individual clutches or of the drive units. As an example, these are the clutch capacities that are currently set or that in future will be set in the course of time or are control commands of the transmission control device to the respective actors. Before a gear change, each clutch with a defined capacity and each further drive unit is precontrolled in the fixed gear to a defined torque, which respectively represent state quantities. During a gear change, each clutch and each further drive unit is subjected to actuating variables or actuating quantities that adjust the desired clutch capacity or the desired torque to be delivered in the course of time. The state and actuating quantities exist for each clutch and each further drive unit independently of whether these are being brought actively, i.e. during the current gear change, into or out of engagement.

In some embodiments, the calculation of the at least one transformation equivalent may comprise the calculation of an equivalent drive mass moment of inertia (Jᵢₙ^{(DCT)}) in dependence on the gear-change-pair-dependent drive mass moment of inertia (Jᵢₙ^{(i,j)}) and of the gear-change-pair-dependent output mass moment of inertia (Jₒᵤₜ^{(i,j)}) and of an rpm ratio (ωₒᵤₜ/ωᵢₙ) of the output shaft rpm (ωₒᵤₜ) and of the drive shaft rpm (ωᵢₙ) and of the coefficients (a^{(i,j)}), preferably (in On of the coupling coefficients (aₒᵤₜ^{(i,j)}, aᵢₙ^{(i,j)}). As already mentioned, the equivalent drive mass moment of inertia is used to condition the gear-change-pair-dependent drive and output mass moments of inertia, taking into consideration output-coupling-related disturbance torques for the load-switching core independently of gear-change pair, so that this can use a drive mass moment of inertia equivalent to it for the shifting-sequence control.

In some embodiments, the calculation of the at least one transformation equivalent may comprise the calculation of dual-clutch-transmission-specific input-shaft rpms (ωᵢₙ^{(DCT)}) in dependence on the gear-change pair (i, j) and on the output-shaft rpm (ωₒᵤₜ^{(i,j)}) as well as on the actual gear ratio (yᵢ) and on the target gear ratio (yⱼ). The dual-clutch transmission has two parallel sub-transmissions, which respectively have an input and an output shaft. The two input-shaft rpms are identical and correspond to the rpm of the (first) drive unit, more precisely to its crankshaft rpm. Both output-shaft rpms then depend on the respective transmission ratio of the sub-transmission, which in turn is selected on the basis of the driver's request. In AT transmissions, the clutch rpms (transmission-input-side clutch rpm ωᵢₙ^{(i,j)}), also referred to as clutch-input rpm, and transmission-output-side clutch rpm ωₒᵤₜ^{(i,j)}, also referred to as clutch-output rpm), i.e. the drive-shaft and output-shaft rpms assigned to the respective clutch, depending on their topological arrangement relative to the transmission input shaft. The clutch input rpm of each clutch may be different from the clutch input rpms of the other clutches as well as from the rpm of the first drive unit, more precisely its crankshaft rpm. Thus, in the AT transmission, not only the initial rpms but also the input rpms of the clutches must be determined. These rpms may be mathematically converted into an equivalent dual-clutch-transmission-specific input-shaft rpm (ωᵢₙ^{(DCT)}). Advantageously, a more precise instruction of actuating quantities by the DCT load-switching core is made possible thereby.

In some embodiments, the calculation of the transformation equivalent may comprise the calculation of effective directions of the cutting torques (T_{cut,blb}) for the m clutches that remain closed in dependence on the gear-change pair (i, j) and of the clutch-input rpm (ωᵢₙ^{(i,j)}) and of the clutch-output rpm (ωₒᵤₜ^{(i,j)}) of then clutches. The effective directions are slip-dependent and can be determined simply from the clutch input and output rpms, taking into consideration the gear-change pair.

In some embodiments, the calculation of the transformation equivalents may comprise the calculation of the effective direction of the holding torque (T_{out,EM}) of the at least one further drive unit.

Furthermore, in some embodiments, the calculation of the transformation equivalents may comprise the calculation of effective-direction-adapted coefficients (\tilde{c}^{(i,j)}) in dependence on the calculated effective directions of the cutting torques (T_{cut,blb}) and of the coefficients (c^{(i,j)}) for determination of the cutting torques (T_{cut,blb}) for the m clutches that remain closed. Advantageously, the complexity of the further steps of the method according to the invention can be reduced by this intermediate step, as can therefore the maximum computational load due to sequential processing.

Furthermore, in some embodiments of the method according to the invention, the calculation of the at least one transformation equivalent may comprise the calculation of the cutting torque (T_{cut,blb}) on the m clutches that remain closed in dependence on the effective-direction-adapted coefficients (\tilde{c}^{(i,j)}) and of the drive torque (Tᵢₙ) and of the currently set clutch capacities (T_{cap}) of then clutches and of the current output gradient (\dot{ω}ₒᵤₜ) and of the drive torque (T_{EM}) currently made available by the at least one further drive unit and present at an element of the hybridized automatic transmission. Alternatively to this, in some embodiments of the method according to the invention, the calculation of the transformation equivalents may comprise the calculation of the cutting torques (T_{cut,blb}) on the m clutches that remain closed in dependence on the coefficients (C^{(i,j)}) and on the effective directions and on the drive torque (Tᵢₙ) of the first and/or of the at least one further drive unit and on the currently set clutch capacities(T_{cap}) of the none or at least one on-coming and of the none or at least one off-going clutch and of the none or at least one clutch that remains closed and on the current output gradient (\dot{ω}ₒᵤₜ) and on the drive torque (T_{EM}) currently made available by the at least one further drive unit and present at an element of the hybridized automatic transmission. In the present method, it is also possible to use, for the calculation, the drive gradient instead of the drive torque and also the output torque instead of the output gradient. Independently of this, the requested output gradient or a measured output gradient may be used.

Finally, in some embodiments of the method according to the invention, the calculation of at least one transformation equivalent may comprise the calculation of a dual-clutch-transmission-specific extra-contact-pressure factor (K_{Üb,scale}^{(DCT)}) and/or of a dual-clutch-transmission-specific extra-contact-pressure offset value (K_{Üb,offset} ^{(DCT)}) in dependence on the gear-change pair (i, j) and on the effective factors (b^{(i,j)}) and in dependence on global scaling factors or clutch-individual scaling factors and/or global offset values or clutch-individual offset values of the n clutches, wherein the global scaling factors or clutch-individual scaling factors and/or global offset values or clutch-individual offset values are selected in dependence on the gear-change pair (i, j) and of the cutting torques (T_{cut,blb}) on the m clutches that remain closed. An extra contact pressure of a clutch means the activation of the clutch actor system with a pressure (alternatively, depending on clutch type, also activation of the clutch actor system with a defined displacement) that presses the two clutch sides (analogously for brakes and housings) so strongly together that a higher torque than would be necessary can be transmitted due to the static friction. This extra contact pressure is applied in order to prevent micro-slip and to transmit the necessary torque safely. During a shifting process of an automatic transmission, two types of extra contact pressure occur, namely at on-coming and off-going clutches as well as a clutches that remain closed. The extra contact pressures at the on-coming and off-going clutches are used to displace the off-going clutch, prior to the shifting process, into a defined state that permits a controlled opening. After the shifting process, the on-coming clutch is subjected to defined extra contact pressure in order to complete the shifting process in controlled manner. This takes place by means of scaling factors or offset values, which may be identical for all clutches or predetermined individually for each clutch, depending on gear-change pair. Such an extra contact pressure may also take place in dual-clutch transmissions, where it is always constant for the two clutches. Thus the automatic-transmission-specific scaling factors and offset values must be transformed or translated into dual-clutch-transmission-specific extra-contact-pressure factors or extra-contact-pressure offset values, which is done on the basis of the effective factors. Advantageously, an extra-contact-pressure control for a better-defined shifting-process configuration via the DCT load-switching core therefore fits into the shifting method according to the invention. The extra contact pressure on the clutches that remain closed is intended to prevent slip during the gear-change process. No counterpart to this exists in the dual-clutch transmission, and so the scaling factors and offset values (global or clutch-individual) may be selected in dependence on the cutting torques. For example, if only a partial-load torque is present at the transmission input, the torques to be transmitted, i.e. the determinable cutting torques, are smaller than at full load. Thus an offset value may turn out to be smaller at partial load than at full load. Scaling factors may be selected by analogy therewith or independently thereof.

Thereafter the supply of the at least one input variable and/or of the at least one transformation factor and/or of the at least one transformation equivalent takes place to the dual-clutch-transmission load-switching core and thus to a basic shifting mode of the dual-clutch transmission. The DCT load-switching core may be constructed on a separate transmission control device and the variables may be obtained or received in hard-wired manner, e.g. via a bus system, or wirelessly. Alternatively, a basic-shifting mode is constructed on the same transmission control device or control-device network as the calculation of the variables, whereby the supply of the variables may be based on known data-technology exchange.

In the next step of the method according to the invention, at least one dual-clutch-transmission-specific actuating quantity, i.e. the dual-clutch-transmission-specific actuating variable, is calculated by a basic shifting mode in dependence on at least one actual variable and/or on the at least one transformation factor and/or on the at least one transformation equivalent. The dual-clutch-specific actuating quantities are the control commands that the transmission control device would output to the respective actors, such as clutch-actuating valves of clutch-actuating cylinders of a dual-clutch transmission.

In some embodiments, the dual-clutch-transmission-specific actuating quantity may comprise a relative drive gradient (Δ\dot{ω}_{VKM}) and/or a relative drive torque (ΔT_{VKM}) of the first drive unit for rpm transfer. The relative drive gradient (Δ\dot{ω}_{VKM}) is instructed or predetermined by a basic shifting mode, i.e. the dual-clutch-specific load-switching core. It is formed such that a desired curve of rpm of the drive shaft versus time is obtained and typically depends on the application of the shifting time and further application parameters, such as the shifting comfort. Alternatively or additionally, it is possible to determine a relative drive torque (ΔT_{VKM}) that is requested by the first drive unit in order to execute or to assist the rpm transfer.

In some embodiments, the at least one dual-clutch-transmission-specific actuating quantity comprises basic-clutch capacities (T_{cap,kom}^{(DCT)}, T_{cap,geh}^{(DCT)}) for load acceptance during the shifting process for the on-coming and off-going clutch, wherein the basic-clutch capacities (T_{cap,kom}^{(DCT)}, T_{cap,geh}^{(DCT)}) can be mathematically converted by evaluation with the respective effective direction to basic-clutch torques (T_{cl,kom,nom}^{(DCT}, T_{cl,geh,nom}^{(DCT)}). These basic clutch capacities are the relevant control variables for load acceptance during a shifting process of a dual-clutch transmission and they correspond to the decreasing (off-going clutch) and increasing (on-coming clutch) clutch capacities. The clutch torques to be transmitted are obtained from the effective-direction-evaluated clutch capacities. Thus the basic-clutch capacities can also be represented as basic-clutch torques (T_{cl,kom}^{(DCT)}, T_{cl,geh}^{(DCT)}), wherein the sum of the basic clutch torques of on-coming and off-going clutch corresponds to the drive torque to be transmitted (taking into consideration the product of drive and output mass moment of inertia and acceleration of the drive and output shafts). The basic-clutch torques (T_{cl,kom}^{(DCT)}, T_{cl,geh}^{(DCT)}) in turn are composed of nominal basic-clutch torques (T_{cl,kom,nom}^{(DCT)}, T_{cl,geh,nom}^{(DCT)}) and relative basic-clutch torques (ΔT _{cl,kom}^{(DCT)}, Δ_{cl,geh}^{(DCT)}). The nominal basic clutch torques correspond to the components for transmission of the drive torque, and the relative basic-clutch torques are used, alternatively or additionally to the relative drive torque, for rpm transfer during a shifting process of a dual-clutch transmission.

Furthermore, in some embodiments, the at least one dual-clutch-transmission-specific actuating variable comprises basic extra-contact-pressure clutch capacities (T_{Üb,kom}^{(DCT)}, T_{Üb,geh} ^{(DCT)}) for extra-contact-pressure control for the on-coming and/or off-going clutch in dependence on the dual-clutch-transmission-specific extra-contact-pressure factor (k_{Üb,scale} ^{(DCT)}) or of the dual-clutch-transmission-specific extra-contact-pressure offset value (k_{Üb,offset}^{(DCT)}). The basic extra-contact-pressure clutch torques to be transmitted are obtained from the effective-direction-evaluated basic extra-contact-pressure clutch capacities and are transmitted over and above the basic clutch torques by the on-coming, load-accepting clutch as well as the off-going, load-delivering clutch. This takes place on the basis of the dual-clutch-transmission-specific extra-contact-pressure factor relative to the nominal torque, and therefore strategically relative to the cutting torque, or absolutely on the basis of the dual-clutch-transmission-specific extra-contact-pressure offset value. In the process, the selectively built-up extra contact pressure present for the off-going clutch is relaxed at the beginning of the shifting process and an extra contact pressure needed for the on-coming clutch is built up selectively at the end of the shifting process. Depending on basic shifting mode, this process may take place in parallel with the load acceptance, in order to save shifting time. This is intended to ensure that the off-going clutch remains closed and can be opened in controlled manner.

In some embodiments, the at least one dual-clutch-transmission-specific actuating quantity comprises a dual-clutch-transmission-specific load-switching torque (T_{EM}^{(DCT)}) at least of one further dual-clutch-transmission-equivalent drive unit, wherein the dual-clutch-transmission-specific load torque (T_{EM}^{(DCT)}) is calculated in dependence on transformation factors and transformation equivalents, such as the effective factors (b^{(i,j)}) and/or on the drive torque (T_{EM}) delivered by the at least one further drive unit and/or on the minimally and and/or maximally transmittable drive torque (T_{EM,min}, T_{EM,max}) of the at least one further drive unit and/or on the holding torque (T_{cut,EM}) of the at least one further drive unit. The dual-clutch-transmission-specific load torque corresponds to a torque that is imposed on this by a virtual further drive unit of the virtual dual-clutch transmission and is determined or calculated by the load-switching core. The load-switching core determines the actuating quantities of the (virtual DCT) clutches for a desired load and rpm transition. This takes place usually for two sub-transmissions, i.e. two clutches. In this connection, the virtual further drive unit may be interpreted as a further sub-transmission. By addition of further parallel sub-transmissions, the load-switching core may be scaled up to a theoretically arbitrary number of further drive units, and so the simultaneous activation of the further drive units is possible. Furthermore, the load-switching core may also control, with only one virtual drive unit, several drive units, provided these do not have to be activated simultaneously. The torque set on the virtual drive unit is then converted mathematically to the corresponding active drive unit, by analogy with the distribution of the virtual capacities to the physically existing clutches. The actuating quantities to be calculated may be determined on the basis of slightly modified equations of the first two sub-transmissions. Besides the arrangement of a further parallel sub-transmission, the further drive unit may also be interpreted as being serial to the first drive unit. This is dependent on the actual structure of the transmission or of the existing gear-change pair. In the case of the serial arrangement, the positive and/or negative torques of the first and further drive units are added together.

In the further course of the method according to the invention, a calculation is made of at least one automatic-transmission-specific actuating quantity in dependence on at least one actual variable and/or on the at least one transformation factor and/or on the at least one transformation equivalent and/or on the at least one dual-clutch-transmission-specific actuating quantity. Preferably, the calculation of the automatic-transmission-specific actuating quantities or actuating variables is made in dependence on several actual variables and several transformation factors and several transformation equivalents and several dual-clutch-transmission-specific actuating quantities. This permits a much more precise calculation of the automatic-transmission-specific actuating quantities with the task-related accomplishment of a smooth, i.e. output-neutral output torque during a load-switching process.

In some embodiments, the calculation of the automatic-transmission-specific actuating quantities may comprise a calculation of load-switching-clutch capacities (T_{cap,kom}^{(AT)}, ) ) (T_{cap,geh}^{(AT)}) for the on-coming and off-going clutch and calculation of a load-switching torque (T_{EM}^{(AT)}) of the at least one further drive unit in dependence on the basic clutch capacities (T_{cap,kom}^{(DCT)}, T_{cap,geh}^{(DCT)}) and on the dual-clutch-transmission-specific load-switching torque (T _{EM}^{(DCT)}) of the at least one further drive unit and of the load factors (b^{(i,j)}) for load acceptance. The basic clutch capacities, set by a basic shifting mode, of the on-coming and off-going clutches are back-transformed with the effective factors to the physical automatic-transmission level, wherein the hybrid structure must also be taken into account. The vector of the effective factors (b^{(i,j)}) has a non-zero component only for the respective on-coming and off-going clutches as well as for, depending on gear-change pair, the at least one further drive unit. If precisely one on-coming and one off-going clutch were to be involved in the automatic transmission during a gear change, the effective factors could alternatively be expressed as scalar variables (bₖₒₘ^{(i,j)}, b_{geh}^{(i,j)}). The load-switching clutch capacities and the load-switching torque (T_{EM}^{(AT)}) form that part of the (clutch) capacities to be set which is responsible or necessary for the pure load acceptance during the process of gear shifting at AT level.

Furthermore, in some embodiments, the calculation of the automatic-transmission-specific actuating quantities may comprise a calculation of an engagement torque (ΔTᵢₙ) of the first and/or of the at least one further drive unit and/or at least of one engagement torque (ΔT_{cl}) of the none or at least one on-coming and/or of the none or at least one off-going and/or of the none or at least one maintained clutch in dependence on the gear-change pair (i, j) and on the relative drive gradient (Δ\dot{ω}_{VKM}) for rpm transfer. The process of rpm transfer is known in principle. Positive and negative engagement torques are output by the drive unit, in order to obtain an output torque that is as constant as possible, depending on shifting type, for example pull upshift or push upshift. Depending on operating or working point of the first drive unit, it may occur that this alone does not have enough potential to supply a positive engagement torque (working-point-dependent drive power not adequately available) or negative engagement torque (drag torque exhausted) of adequate magnitude. In these cases, engagement torques that hold the output torque as constant as possible or the output gradient as smooth as possible may be transmitted by the on-coming, the off-going or, if present in the existing gear-change pair, the maintained clutches or by the at least one further drive unit. In some cases, it may be sufficient to execute clutch engagements alone, i.e. without outputting or activating engagement torques of the first and/or of the at least one further drive unit, in order to keep the output torque constant during the rpm transfer. Engagement torques of the clutches and drive units, just as precontrol torques, can be mathematically converted via the effective direction into actuating capacities.

Furthermore, in some embodiments, the calculation of the automatic-transmission-specific actuating quantities may comprise a calculation at least of a compensating torque (ΔT_{cl,komp}) of the none or at least one on-coming and/or of the none or at least one off-going and/or of the none or at least one open clutch and/or of one compensating torque (ΔT_{EM,komp}) of the at least one further drive unit in dependence on the engagement torque (ΔTᵢₙ) of the first and/or of the at least one further drive unit and/or on the at least one engagement torque (ΔT,_{cl}) of the none on-coming and/or of the none or at least one off-going and/or of the none or at least one closed clutch and/or on the output gradient (\dot{ω}) and/or of the coefficients (aₒᵤₜ^{(i,j)}, aᵢₙ^{(i,j)}) and/or on the gear-change-pair-dependent output mass moment of inerta (Jₒᵤₜ^{(i,j)}). During engagements of the first drive unit, disturbance factors occur in the sense of disturbance torques, which are imposed on the output due to the coupling between drive and output via a power path, which remains closed, of the hybridized automatic transmission and are perceptible as non-output-neutral. The process of output-neutral load switching is referred to as compensation, because disturbing torques, caused by couplings of the drive and output sides of the hybridized automatic transmission are compensated, i.e. evened out. These disturbing torques may be measured directly or indirectly, although this is very complex and also makes a precontrol or canceling-out of the disturbance torques very complex and resource-intensive. The monitoring of rpm fluctuations on the output or of deviations of the output gradient is simpler. However, it is only by means of precontrol that is exact as possible that a satisfactory regulation quality can be achieved in correspondingly short time. Therefore the compensating torques of the affected clutches and of the at least one further drive unit are determined as precisely as possible and incorporated in the precontrol, i.e. the instruction of the clutch capacities. In this connection, the output gradient, just as for dual-clutch transmissions, is intended to remain unimpaired by the rpm transfer on the drive; this may be ensured by corresponding compensation torques of the clutches or of the at least one further drive unit in the automatic transmission.

Compensation engagements may take place both during the phase of rpm transfer and during the phase of load acceptance. If an engagement of the first drive unit takes place by application of an engagement torque, preferably during the rpm-transfer phase, a part of this engagement torque is relayed via the closed power path to the output. This part of the engagement torque is to be compensated. In the case of a relatively negative engagement torque, for example during upshifts, the compensation may take place by an increased clutch capacity of a suitable clutch, in order, for example, to avoid a torque collapse at the output. A clutch to which sufficient positive or negative torque-transmission capacity is still available is suitable. Suitable clutches are determined via disturbance terms that are transmission-topology-dependent, i.e. dependent on the specific transmission coefficients, in the equations of motion. A particularly suitable clutch is an open clutch. Alternatively or additionally to compensation by means of the at least one clutch that remains open, the compensation takes place by the fact that, during the shifting process, preferably during the phase of rpm transfer, an engagement torque of the at least one further drive unit is applied to an active, i.e. an on-coming or off-going clutch or clutch that remains closed or to a non-active power path, i.e. one that remains open. In this connection, the at least one further drive unit is preferably an E-machine, integrated in the transmission, that is able to compensate, in a manner dependent on effective direction, any disturbance torque up to its maximum torque capacity, or a maximally transmittable drive torque by acceleration or braking of transmission elements of the respective power path. Advantageously, such a compensation can be executed particularly simply and precisely, although it is applicable only when at least one further drive unit is built into or onto the transmission and by means of it a direct engagement into a power path or a gear stage is possible. The at least one further drive unit, preferably an E-machine, just as a clutch, may be installed at arbitrary position in the transmission. Because of the electrical supply or the required recuperation capability, however, it is usually mounted as a brake between frame and a transmission shaft. The mounting between two shafts would also be possible. Thereby, due to the nature of the construction, the at least one further drive unit is able to apply an engagement torque only to a limited number of power paths. In turn, however, it is possible to deliver a bidirectional engagement torque to the possible power paths, whereby a further degree of freedom for an engagement is gained. In principle, the determination of the engagement torque is subject, however, to the same conditions as the determination of the engagement torque of the open clutches and it can be implemented in a way known in itself by the control unit of the at least one further drive unit. If engagement torques are applied both by open clutches and by the at least one further drive unit, on the one hand a further range of operating states can be covered particularly advantageously and on the other hand a compensation can take place with minimal engagements for the respective operating point. Beyond this, output-coupling-related disturbance torques may also occur during the load acceptance. In this connection, torque fluctuations on the output, caused by the gear-change-related torque-transmission changes, act at least on the first drive unit. These output-coupling-related disturbance torques occurring during the load acceptance may likewise be compensated by compensation torques of the none or at least one on-coming and/or of the none or at least one off-going and/or of the none or at least one open clutch and/or of the at least one further drive unit, preferably by compensation torques of the none or at least one on-coming and/or off-going clutch. The necessary compensating torque is determined in dependence on the output gradient (\dot{ω}ₒᵤₜ) and the coefficients(a^{(i,j)}), preferably the coupling coefficients (aₒᵤₜ^{(i,j)}, aᵢₙ^{(i,j)}) and the gear-change-pair-dependent output mass moment of inertia (Jₒᵤₜ^{(i,j)}).

In some embodiments, the calculation of the automatic-transmission-specific actuating quantities may comprise the calculation of extra-contact-pressure clutch capacities (T_{Üb,blb}) of the none or at least one clutch that remains closed in dependence on the cutting torques (T_{cut,blb}) for the m clutches that remain closed and the global scaling factor or clutch-individual scaling factors and/or on the global offset values or clutch-individual offset values of the n clutches.

Furthermore, in some embodiments, the calculation of the automatic-transmission-specific actuating quantities may include the calculation of extra-contact-pressure clutch capacities (T_{Üb,kom}^{(AT)}, (T_{Üb,geh}^{(AT)}) of the at least one on-coming and of the at least one off-going clutch in dependence on the basic extra-contact-pressure clutch capacities (T_{Üb,kom}^{(DCT)}, (T_{Üb,geh}^{(DCT)}) and on the effective factors (b^{(i,j)}).

In some embodiments, the calculation of the automatic-transmission-specific actuating quantities comprises the calculation of the clutch capacities (T_{cap}) to be set for the n clutches and of the drive torque (T_{EM}) to be set for the at least one further drive unit in dependence on the load-switching clutch capacities (T_{cap,kom}^{(AT)}, (T_{cap,geh}^{(AT)}) and/or on the load-switching torque (T_{EM}^{(AT)}) of the at least one further drive unit and/or on the extra-contact-pressure clutch capacities (T_{Üb,kom}^{(AT)}, (T_{Üb,geh}^{(AT)}) for the none or at least one on-coming and the none or at least one off-going clutch and/or on the extra-contact-pressure clutch capacities (T_{Üb,blb}) of the none or at least one clutch that remains closed and/or on the cutting torques (T_{cut,blb}) of the m clutches that remain closed and/or on the engagement torque (ΔTᵢₙ) of the first and/or of the at least one further drive unit and/or on the engagement torque (ΔT_{cl}) of the none or at least one on-coming and/or of the none or at least one off-going clutch and/or of the none or at least one clutch that remains closed and/or on the at least one compensating torque (ΔT_{cl,komp}) of the none or at least one on-coming and/or of the none or at least one off-going and/or of the none or at least one open clutch and/or on the compensation torque (ΔT_{EM,komp}) of the at least one further drive unit. Preferably, the clutch capacities actually to be set are determined in dependence on as many as possible, particularly preferably in dependence on all mentioned alternatives, whereby a particularly smooth load and rpm transition is achieved, because the precontrol of the (clutch) capacities takes place as exactly as possible, whereby subsequent regulation is not necessary or is minimized in complexity and thus the regulation quality can be maximized.

Finally, in the last step of the method according to the invention, the implementation of the at least one automatic-transmission-specific actuating quantity takes place by at least one actuator and the at least one further drive unit. For this purpose, the actuating quantities or actuating variables are transmitted by way of suitable means, e.g. via a CAN bus, to the actors and the at least one further drive unit, e.g. hydraulic clutch-actuating cylinders and an E-machine, optionally with intermediate connection of a transmission or hybrid control device (hybrid manager) and implemented by these.

In one advantageous embodiment, the calculation of the transformation equivalents comprises, alternatively or additionally, the calculation of dual-clutch-transmission-specific maximally settable clutch capacities (T_{cap,geh,max}^{(DCT)}, (T_{cap,kom,max}^{(DCT)}) in dependence on the maximally transmittable clutch capacities (T_{cap,max}) of then clutches and/or of the minimally and/or maximally available drive torques (T_{in,min}, T_{in,max}) of the first and/or of the at least one further drive unit, wherein the basic clutch capacities (T_{cap,kom}^{(DCT)}, (T_{cap,geh}^{(DCT)}) for load acceptance during the shifting process for the on-coming and the off-going clutch are additionally determined in dependence on the dual-clutch-transmission-specific maximally settable clutch capacities (T_{cap,geh,max}^{(DCT)}, T_{cap,kom,max}^{(DCT)}). The maximally transmittable clutch capacity depends on the properties of the clutch. The dual-clutch-transmission-specific maximally settable clutch capacities are advantageously determined both in dependence on the properties of the clutch (maximally transmittable clutch capacity) and on the current parameters of the first and/or of the at least one further drive unit (minimally/maximally available drive torque). The determination of the basic clutch capacities in dependence on the dual-clutch-transmission-specific maximally settable clutch capacities substantially increases the precision of the precontrol and makes it possible to take into consideration all operating ranges for the load-switching of hybridized automatic transmissions. Furthermore, as a boundary condition, the dual-clutch-transmission-specific maximally settable clutch capacities may prevent nominal values, which are computationally possible but in practice cannot be implemented, for clutch capacities to be set.

In one particularly advantageous embodiment, the selection of the transformation factors comprises, alternatively or additionally, the selection of a dual-clutch-transmission-specific minimally and/or maximally realizable drive gradients (\dot{ω}ᵢₙ^{(DCT)}, \dot{ω}ₘₐₓ^{(DCT)}) or a dual-clutch-transmission-specific minimally and/or maximally realizable drive-gradient change (Δ\dot{ω}ᵢₙ^{(DCT)}, Δ\dot{ω}ₘₐₓ^{(DCT)}) in dependence on at least one actual variable and/or the maximally transmittable clutch capacities (T_{cap,max}) of the n clutches and/or of the minimally and/or maximally available drive torque (T_{in,min}, T_{in,max}) of the first and/or of the at least one further drive unit.

This has in turn the advantage of keeping reserves available for additional engagements, e.g. compensation engagements. In this connection, the minimal and/or maximal drive-gradient change may also be used instead of the minimal/maximal drive gradients.

### Exemplary Embodiment

Further features, application possibilities and advantages of the invention will become apparent from the following description of exemplary embodiments of the invention, which are illustrated schematically in the figures. In this connection, all described or illustrated features individually or in arbitrary combination form the subject matter of the invention, regardless of their association in the claims or their cross-referencing as well as regardless of their wording or illustration in the description and in the figures.

Herein,

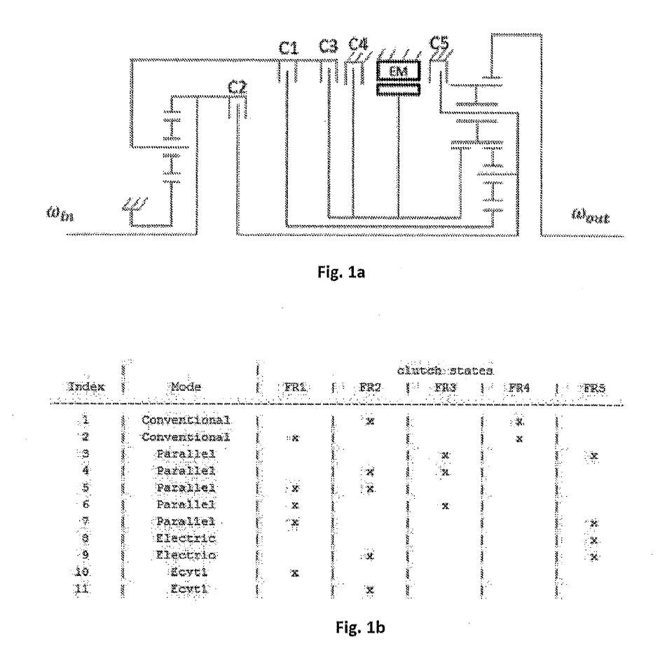

FIGS. 1a-b show the diagram of an automatic transmission (AT) hybridized by means of an E-machine on the basis of a transmission topology and a table of clutch states,

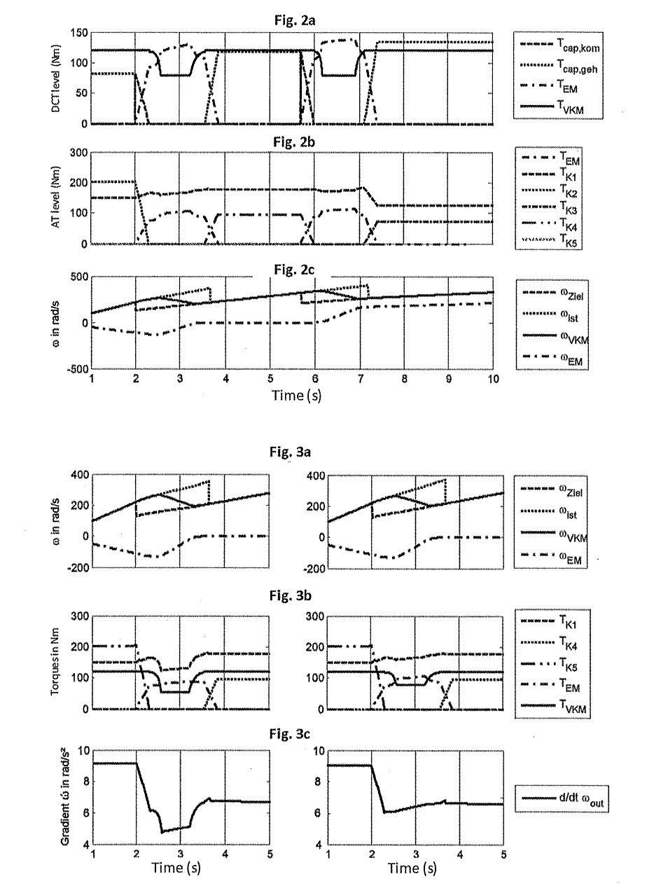

FIGS. 2a-c show a schematic comparison of clutch capacities of a dual-clutch transmission (DCT), clutch capacities and the drive torque of an automatic transmission hybridized with an E-machine as well as an rpm transfer illustrated in simplified manner by an eCVT gear,

FIGS. 3a-c show the comparison of a load switching compensated with an E-machine and one not compensated,

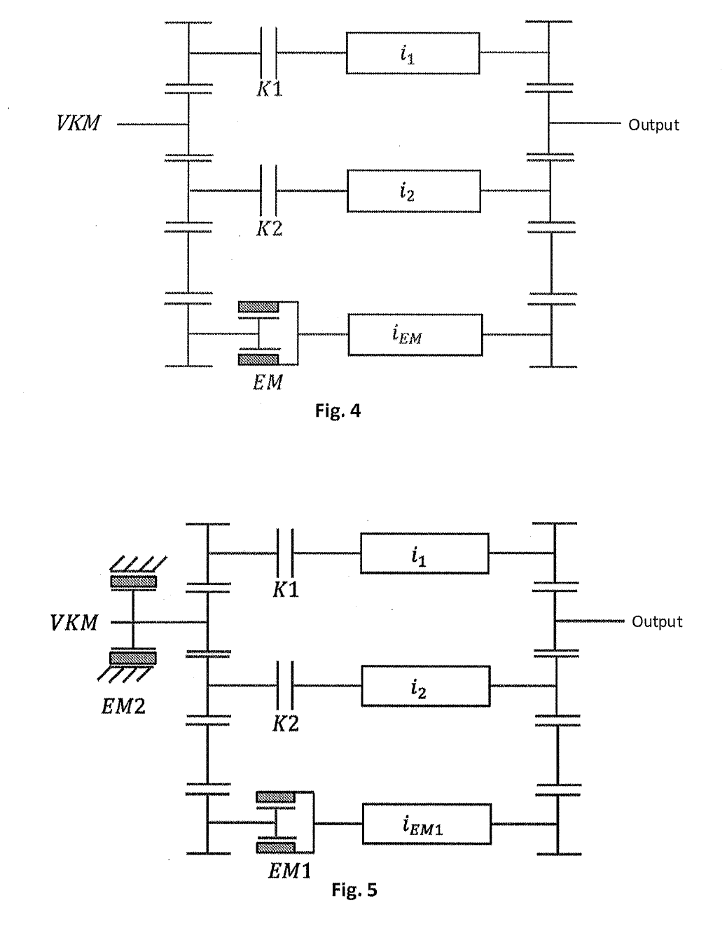

FIG. 4 shows the schematic representation of a dual-clutch-transmission-equivalent view of an arbitrary hybridized automatic transmission with an E-machine,

FIG. 5 shows the schematic representation of a dual-clutch-transmission-equivalent view of an arbitrary hybridized automatic transmission including a shiftable eCVT transmission, with two E-machines and output-power branching (output split) and

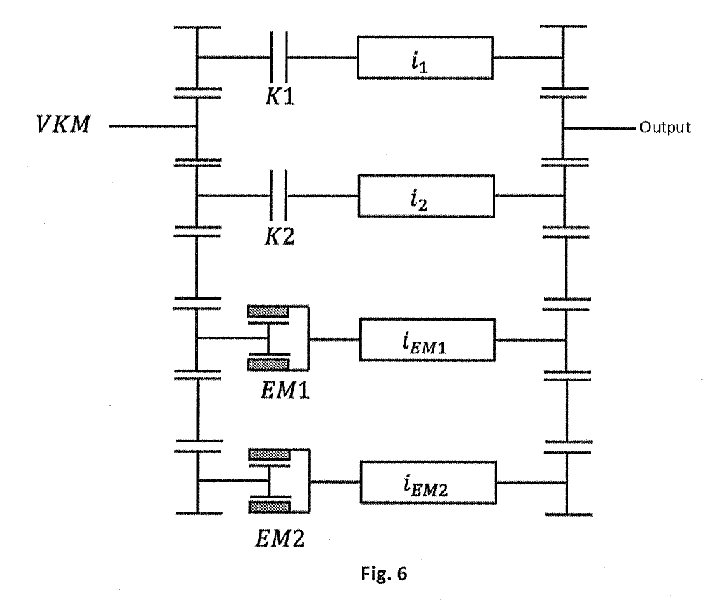

FIG. 6 shows the schematic representation of a dual-clutch-transmission-equivalent view of an arbitrary hybridized automatic transmission including a shiftable eCVT transmission, with two E-machines and input-power branching (input split) or double power branching (compound split).

The method for load switching of hybridized automatic transmissions is based on parts of the method, disclosed in the non-prepublished German Patent Application DE 10 2015 120 599.8, for load switching of automatic transmissions, the entire content of which is herewith explicitly incorporated in the present disclosure. In comparison therewith, at least one further drive machine in the form of an E-machine is additionally involved on the gear change, which also comprises the mode-of-operation changeover of the hybridized automatic transmission. From the viewpoint of the transmission control or transmission regulation, the E-machine corresponds to a torque source analogous to a clutch, except only that the effective direction can be bilateral.

With a hybridized automatic transmission such as illustrated in FIG. 1a, several modes of operation can be represented, e.g. electric driving, internal-combustion-engine driving and hybridized driving. These modes of operation correspond to those of a so-called parallel hybrid vehicle. FIG. 1a shows the diagram of the transmission topology of an automatic transmission according to Lepelletier with a simple planet gearset, a Ravigneaux gearset, three clutches C1, C2 and C3, two brakes C4 and C5, which in the following will likewise be described and referred to as clutches, and an E-machine EM.

FIG. 1b shows a table of clutch states, which determines, for each fixed (conventional), each hybridized-operated (parallel), each purely electrically actuated (electric) and each continuously variably transmitted gear (eCVT), whether the status (clutch states) of the respective clutch (FR1 to FR5) is to be open or closed (marked by x). During a gear change, an eCVT mode takes place, in which the gear ratio can be adjusted continuously variably between primary drive source, here internal combustion engine, and output by the E-machine and the internal combustion engine is supported via the E-machine. According to FIG. 1b, an eCVT mode can be realized in the present example for all gear changes in which either the first (FR1 ) or the second clutch (FR2) remains closed.

FIG. 2 shows two gear-change processes, from the 1st gear into the 2nd gear and from the 2nd gear into the 3rd gear. As can be seen in FIG. 2b, during rpm transfer the E-machine (T_{EM}) takes over the function of the load-bearing clutch in the shifting process of conventional automatic transmissions. Depending on shifting type (pull or push), this corresponds to the on-coming or off-going clutch. During the load acceptance, the off-going clutch, still bearing the load, is relieved by the imposition of a drive torque with the E-machine. As soon as the off-going clutch is load-free, it is opened. The state achieved at this instant corresponds to an eCVT gear. If the gear-change process were ended at this instant, the eCVT1 gear would be engaged, in which the gear ratio of the automatic transmission could be adjusted infinitely variably with change of the applied drive torque of the internal combustion machine VKM and of the supporting drive torque of the E-machine EM. The rpm transfer or adjustment of the rpm is realized by the eCVT gear in dependence on the rpm gradient instructed by the load-switching core. This phase lasts between seconds 2 and 4 (gear-change process from 1st gear into 2nd gear). During this time, as already mentioned, the rpm transfer takes place, which is implemented by a reduction of the drive torque (T_{VKM}) of the first drive unit, i.e. of the internal combustion engine. At the level of the dual-clutch transmission, this can be seen in FIG. 2a. Finally, FIG. 2c shows the rpms of the off-going gear (ωᵢₛₜ), of the on-coming gear (ω_{Ziel}), of the internal combustion engine (ω_{VKM}) and of the E-machine (ω_{EM}).

The comparison of a compensated and non-compensated gear change can be seen in FIG. 3. The compensation takes place during the rpm transfer. In the process, the rpm of the internal combustion engine (VKM) is transferred in eCVT mode to the rpm of the target gear by a combined VKM-EM engagement, whereby the drive gradient \dot{ω}ₒᵤₜ can be smoothly maintained. The compensation of a disturbance torque is illustrated in the non-prepublished German Patent Application DE 10 2015 120 601.3, the entire content of which is herewith explicitly incorporated in the present disclosure, and where the specific determination of the individual drive, engagement and compensation torques is explained by way of examples.

Specifically, the rpm ratios of the current gear ωᵢₛₜ, of the on-coming gear ω_{Ziel}, of the internal combustion engine ω_{VKM} and of the E-machine ω_{EM} can be seen in FIG. 3a. These are identical both during a compensated and during a non-compensated gear-change process.

The torque ratios, illustrated in FIG. 3b, during a gear-change process from gear 1 to gear 2 differ depending on whether a compensated gear-change process (right) or a non-compensated gear-change process (left) is taking place. At second 2, the load T_{KS} of the off-going clutch C5 is transmitted to the E-machine T_{EM}. After the load acceptance by the E-machine has taken place, a reduction of the drive torque Tᵢₙ of the internal combustion engine begins (approx. second 2.3), in order to transfer the rpm of the internal combustion engine ω_{VKM} as seen in FIG. 3a to the new target rpm ω_{Ziel}. Because of the coupling between drive and output via the power path, which remains closed, of clutch 1, the torque T_{K1} transmitted via this power path to the output (compare with approx. second 2.3 in FIG. 3b left) is reduced, which is perceptible by a gradient collapse \dot{ω}ₒᵤₜ at the output. In order to compensate this collapse, a combined engagement takes place, comprising a smaller drive-torque reduction Tᵢₙ and an increased drive torque T_{EM} of the E-machine (see FIG. 3b right), respectively in comparison with the non-compensated gear-change process. Thereby the torque transmitted via the power path that remains closed is held almost constant and, after a necessary first reduction has occurred, caused by the changing gear ratio during the load acceptance, the output gradient \dot{ω}ₒᵤₜ likewise remains approximately constant (see FIG. 3c right) and a smoother and more comfortable gear-change process takes place without traction-force interruption. The reduction of the output gradient may be prevented by the application of the wheel-torque concept. In the process, the drive torque is correspondingly increased during the load acceptance.

As soon as the rpm of the internal combustion engine ω_{VKM} has adapted to the rpm of the new on-coming gear ω_{Ziel}, the load is transmitted from the E-machine to the on-coming clutch C4 (see time interval from second 3.5 to approx. 3.8 in FIG. 3b right).

What is important for the method according to the invention is the transformation of the measured or present actual variables into dual-clutch-transmission-specific variables, more precisely into the transformation equivalents. From these variables, the DCT load-switching core then determines the DCT-specific actuating variables, which in turn are back-transformed into automatic-transmission-specific actuating variables. In order that this transformation can also be applied for hybridized automatic transmissions, the further drive unit, here the E-machine EM, must be transformed into a dual-clutch-transmission-equivalent view. Such a view is represented as a dual-clutch-transmission diagram in FIG. 4. In this connection, it is apparent that the E-machine EM is assumed to be a further parallel-shifted sub-transmission. The power flow takes place from the internal combustion engine VKM via one of the three sub-transmissions to the output. Via the clutches K1 and K2, the two conventional sub-transmissions connect the internal combustion engine alternatingly with the output. Each of these two sub-transmissions has a fixed transmission ratio i₁ or i₂, which differs depending on engaged gear stage. The transmission ratio is designated as fixed because the clutch in the closed state relays the VKM rpm unchangeably to the transmission element forming the gear ratio, e.g. gearwheels. In contrast to this, the E-machine EM is able in the third sub-transmission to map the function of a clutch, i.e. the approaching and the matching of the VKM rpm to the rpm of the sub-transmission input shaft, and the function of a CVT transmission. In the process, the rpm of the E-machine and thus the relative rpm between VKM output shaft and sub-transmission input shaft are infinitely varied. The application of this simple transmission scheme for automatic transmissions is particularly advantageous because, independently thereof, where the E-machine EM is disposed in the automatic transmission, the application of the transmission scheme is ensured via the transformation factors.

The calculation of the actuating variables takes place on the basis of a wheel-torque or requested-torque concept, which interprets the drive torque to be transmitted via the drive wheels to the roadway as a requested torque on the basis of the driver's request and/or of a crankshaft-torque concept. In conventional transmissions, the crankshaft-torque concept is adopted for the most part. In this case, a drive torque is predetermined that is applied by the internal combustion engine VKM directly on the crankshaft. In the process, however, the crankshaft torque can be mathematically converted into the wheel torque via the gear ratio, supplied by the transmission control unit, between drive and output. The crankshaft torque can also be mathematically converted into the wheel torque during the change from a fixed gear into an eCVT gear, because the internal combustion engine VKM in the eCVT gear also has a fixed torque-transmission ratio relative to the output. Thus the application of the invention is always possible as a wheel-torque-based control unit.

Hybridized automatic transmissions may also have two or more E-machines. In FIGS. 5 and 6, variants with respectively two E-machines EM1, EM2 are represented. FIG. 5 shows the dual-clutch-transmission-equivalents, i.e. the transformed view of an output-power-branched automatic transmission, also known as output split. Therein one E-machine EM2 is connected directly with the crankshaft. The effective crankshaft torque, previously the drive torque of the internal combustion machine VKM, is then the sum of the drive torques of the VKM and of the E-machine EM2. The other E-machine EM1 supports this summation torque, whereby a torque is transmitted to the output. The changeover between a fixed gear with constant gear ratio and an eCVT mode with variable gear ratio then takes place as described above, with the difference that the drive-shaft torque is formed from two source torques. By analogy with a vehicle having parallel hybrid drive, a further degree of freedom is obtained in the engine and transmission control unit by the distribution of the summation torque to the internal combustion engine VKM and the E-machine EM2.

FIG. 6 shows the dual-clutch-transmission-equivalent view of an input-power-branched and a doubly power-branched automatic transmission. In an input-power-branched automatic transmission known in itself, also referred to as input split, the internal combustion engine VKM is supported by an E-machine EM1. This means that the E-machine EM1, for example, engages with and applies a torque on the sun wheel of a planetary transmission, so that the internal combustion engine VKM is able to apply a torque on, for example, the planet carrier, whereby the ring gear is able to deliver a desired and selectively transmitted drive torque to the output shaft. In the conventional automatic transmission without further drive units, a clutch or a brake would support the sun wheel against the housing. In contrast, the example described here has a further degree of freedom, which is characterized by an eCVT mode on the basis of variable rpms of the E-machine EM1. The second E-machine EM2 is coupled directly with the output. Due to the E-machine EM1, the wheel nominal torque can be distributed to the E-machine EM2 on the output and the internal combustion engine VKM. The changeover between a fixed gear with constant gear ratio and an eCVT mode with variable gear ratio then takes place as described above, with the difference that the magnitude of the drive torque of the internal combustion engine VKM can be varied, for constant wheel nominal torque, by application of a drive torque by the E-machine EM2 directly on the output. Thereby load-point displacements of the VKM and thus better efficiencies are possible. In addition, it is possible to use the E-machine EM2 on the output for compensation of disturbance influences in rpm transfers during changeover or gear-change processes.

A doubly power-branched automatic transmission, also referred to as compound split, has at least two sub-transmissions, preferably two planet-gear transmissions, and in terms of the transmission structure and the transmission control is much more complex than an input-power-branched automatic transmission. Nevertheless, it can be represented in the same dual-clutch-transmission-equivalent view as the latter, even on the basis of the equivalent treatment of clutches, brakes and, depending on the gear-change combination, E-machines, as equivalent to a clutch with additional degrees of freedom in magnitude and effective direction. This further illustrates the great advantageousness of the method according to the invention for output-neutral load switching. In the compound split or doubly branched automatic transmissions, both E-machines EM1 and EM2 may be used to support the internal combustion engine VKM. Thereby the torque applied by the further drive units can be distributed to the two E-machines in dependence on the nominal wheel torque and on the drive torque of the internal combustion engine VKM. In addition, a further degree of freedom is obtained by the fact that the torque for supporting the internal combustion engine VKM can be distributed to both E-machines. These additional degrees of freedom permit both a more efficient constructive design of the entire drive train and a load-point displacement of the individual drive units in the direction of (global) operating optimum. The changeover process between individual fixed gears or between a fixed gear and an eCVT mode takes place as described above, with the difference that both E-machines can be used for transfer of the load. Depending on E-machine used for the changeover to eCVT mode or depending on combination of two E-machines used, a different transmission ratio is obtained between internal combustion engine and output in dependence on support factors of the E-machines.

1. A method for output-neutral load switching of hybridized automatic transmissions with an arbitrary number of gears and a number n of clutches and with a first of p drive units and at least one further of p drive units on the basis of a transformation of real transmission variables of the hybridized automatic transmission to virtual variables of a dual-clutch transmission with associated dual-clutch-transmission-specific basic shifting modes comprising the following steps:
initiation of a shifting process for a gear-change pair (i, j) from a gear i with an actual gear ratio (yᵢ) to a gear j with a target gear ratio (yⱼ) in dependence on a target gear preselection,
sensing of actual variables of the hybridized automatic transmission and of the first and/or of the at least one further drive unit, wherein the actual variables comprise at least one of the following variables:
a drive shaft rpm (ωᵢₙ) of at least one drive shaft of the hybridized automatic transmission,
an output shaft rpm (ωₒᵤₜ) of an output shaft of the hybridized automatic transmission,
a drive torque (Tᵢₙ) made available by the first and/or by the at least one further drive unit and present at the at least one drive shaft of the hybridized automatic transmission,
currently set clutch capacities (T_{cap}) of the n clutches and/or
a minimally and/or maximally available drive torque (T_{in,min}, T_{in,max}) of the first and/or of the at least one further drive unit,
selection of at least one transformation factor in dependence on at least one actual variable and on the gear-change pair (i, j) from tables of states,
calculation of at least one transformation equivalent for the calculation of at least one dual-clutch-transmission-specific actuating quantity by the basic shifting mode of the dual-clutch transmission in dependence on at least one actual variable and/or on the at least one transformation factor,
calculation of at least one dual-clutch-transmission-specific actuating quantity by a basic shifting mode in dependence on at least one actual variable and/or on the at least one transformation factor and/or on the at least one transformation equivalent,
calculation of at least one automatic-transmission-specific actuating quantity in dependence on at least one actual variable and/or on the at least one transformation factor and/or on the at least one transformation equivalent and/or on the at least one dual-clutch-transmission-specific actuating quantity and
implementation of the at least one automatic-transmission-specific actuating quantity by at least one actuator and by the at least one further drive unit.

2. The method for load switching of hybridized automatic transmissions according to claim 1, wherein the selection of the transformation factors comprises at least one of the following steps:
selection of coefficients (a^{(i,j)}) determining the automatic-transmission topology in dependence on the gear-change pair (i, j) from a table of states.
selection of effective factors (b^{(i,j)}) of clutch capacities (T_{cap}) ᵣ to be set, of the n clutches and of a drive torque (T_{EM}) delivered by one of the at least one further drive units in dependence on the gear-change pair (i, j) from a table of states,
indexing (idx^{(i,j)}) of the none or at least one on-coming (idxₖₒₘ^{(i,j)}) and of the none or at least one off-going (idx_{geh}^{(i,j)}) clutch and of the none or at least one clutch that remains closed (idx_{blb}^{(i,j)}) of then clutches and of the status (idx_{Em}^{(i,j)}) of the at least one further drive unit in dependence on the gear-change pair (i, j) and/or on the selected mode of operation from a table of states,
selection of a gear-change-pair-dependent drive mass moment of inertia (Jᵢₙ^{(i,j)}) of the hybridized automatic transmission and of a gear-change-pair-dependent output mass moment of inertia (Jₒᵤₜ^{(i,j)}) of the hybridized automatic transmission in dependence on the gear-change pair (i, j) from a table of states,
selection of coefficients (c^{i,j)}) for determination of cutting torques (T_{cut,blb}) for the m clutches that remain closed and for determination of a holding torque (T_{cut,EM}) of the at least one further drive units in dependence on the gear-change pair (i, j) from a table of states and/or
selection of maximally transmittable clutch capacities (T_{cap},ₘₐₓ) of the n clutches in dependence on at least one actual variable,
wherein the calculation of the at least one transformation equivalent comprises at least one of the following steps:
calculation of an equivalent drive mass moment of inertia (Jᵢₙ^{(DCT)}) in dependence on the gear-change-pair-dependent drive mass moment of inertia (Jᵢₙ^{(i,j)}) and on the gear-change-pair-dependent output mass moment of inertia (Jₒᵤₜ^{(i,j)}) and on an rpm ratio (ωₒᵤₜ/ωᵢₙ) of the output shaft rpm (ωₒᵤₜ) and on the drive shaft rpm (ωᵢₙ) and on the coefficients (a^{i,j)}),
calculation of dual-clutch-transmission-specific input-shaft rpms (ωᵢₙ⁽ⁱ⁾) and (ωᵢₙ^{(j)}) in dependence on the gear-change pair (i, j) and on the output-shaft rpm (ωₒᵤₜ) as well as on the actual gear ratio (yᵢ) and on the target gear ratio (yⱼ),
calculation of effective directions of the cutting torques (T_{cut,blb}) for the m clutches that remain closed in dependence on the gear-change pair (i, j) and on the clutch rpms (ωᵢₙ^{(i,j)}) and (ωₒᵤₜ^{(i,j)}) of the n clutches,
calculation of effective-direction-adapted coefficients (\tilde{c}^{(i,j)}) in dependence on the calculated effective directions of the cutting torques (T_{cut,blb}) and on the coefficients (c^{(i, j)}) for determination of the cutting torques (T_{cut,blb}) for the m clutches that remain closed, calculation of the cutting torques (T_{cut,blb}) on the m clutches that remain closed and of the holding torque (T_{cut,EM}) of the at least one further drive unit independence on the effective-direction-adapted coefficients (\tilde{c}^{(i,j)}) and on the drive torque (Tᵢₙ) and of the first and/or of the at least one further drive unit and on the currently set clutch capacities (T_{cap}) of the n clutches and on the current output gradient (\dot{ω}ₒᵤₜ) and on the drive torque (T_{EM}) currently made available by the at least one further drive unit and present at an element of the hybridized automatic transmission and/or
calculation of a dual-clutch-transmission-specific extra-contact-pressure factor (k_{Üb,scale}^{(DCT)} and/or on a dual-clutch-transmission-specific extra-contact-pressure offset value (k_{Üb,offset}^{(DCT)}) in dependence on the gear-change pair (i, j) and on the effective factors (b^{(i,j)}) and in dependence on global scaling factors or clutch-individual scaling factors and/or global offset values or clutch-individual offset values of the n clutches.

3. The method for load switching of hybridized automatic transmissions according to claim 1, wherein the at least one dual-clutch-transmission-specific actuating quantity comprises one of the following variables:
a relative drive gradient (Δ\dot{ω}_{VKM}) and/or a relative drive torque (ΔT_{VKM}) of the first drive unit for rpm transfer,
basic-clutch capacities (T_{cap,kom}^{(DCT)}, (T_{cap,geh}^{(DCT)}) for load acceptance during the shifting process for the on-coming and off-going clutch, wherein the basic-clutch capacities (T_{cap,kom}^{(DCT)}, (T_{cap,geh}^{(DCT)}) can be mathematically converted by evaluation with the respective effective direction to basic-clutch torques (T_{cl,kom,nom}^{(DCT)}, (T_{cl,geh,nom}^{(DCT)}) and/or
basic extra-contact-pressure clutch capacities (T_{Üb,kom}^{(DCT)}, T_{Üb,geh}^{(DCT)}) for extra-contact-pressure control for the on-coming and off-going clutch in dependence on the dual-clutch-transmission-specific extra-contact-pressure factor (k_{Üb,scale}^{(DCT)}) and/or on the dual-clutch-transmission-specific extra-contact-pressure offset value (k_{Üb,offset} ^{(DCT)}) and/or
a dual-clutch-transmission-specific load-switching torque (T_{EM}^{(DCT)}) of at least one further dual-clutch-transmission-equivalent drive unit.

4. The method for load switching of hybridized automatic transmissions according to claim 1, wherein the calculation of the automatic-transmission-specific actuating quantities comprises at least one of the following steps:
calculation of load-switching clutch capacities (T_{cap,kom}^{(AT)}, (T_{cap,geh}^{(AT)}) for the on-coming and off-going clutch and calculation of a load-switching torque (T_{EM}^{(AT)}) of the at least one further drive unit in dependence on the basic clutch capacities (T_{cap,kom}^{(DCT)}, T_{cap,geh}^{(DCT)}) and on the effective factors (b^{i,j)}) and on the dual-clutch-transmission-specific load-switching torque (T_{EM}^{(DCT)}) of the at least one further dual-clutch-transmission-equivalent drive unit for load acceptance,
calculation of an engagement torque (ΔTᵢₙ) of the first and/or of the at least one further drive unit and/or at least one engagement torque (ΔT_{cl}) of the none or at least one on-coming and/or of the none or at least one off-going clutch and/or of the none or at least one clutch that remains closed in dependence on the gear-change pair (i, j) and on the relative drive gradients (Δ\dot{ω}_{VKM}) and/or on the relative drive torque (ΔT_{VKM}) of the first drive for rpm transfer,
calculation at least of a compensating torque (ΔT_{cl,komp}) of the none or at least one on-coming and/or of the none or at least one off-going and/or of the none or at least one open clutch and/or on a compensating torque (ΔT_{EM,komp}) of the at least one further drive unit in dependence on the engagement torque (ΔTᵢₙ) of the first and/or of the at least one further drive unit and/or on the at least one engagement torque (ΔT_{cl}) of the none or at least one on-coming and/or of the none or at least one off-going and/or of the none or at least one closed clutch and/or on the output gradient (\dot{ω}ₒᵤₜ ) and/or on the coefficients (aₒᵤₜ^{(i,j)}, aᵢₙ^{(i,j)}) and/or on the gear-change-pair-dependent output mass moment of inertia (Jₒᵤₜ^{(i,j)}),
calculation of extra-contact-pressure clutch capacities (T_{Üb,blb}) of the none or at least one clutch that remains closed in dependence on the cutting torques (T_{cut,blb}) for the m clutches that remain closed and on the global scaling factor or clutch-individual scaling factors and/or on the global offset values or clutch-individual offset values of the n clutches,
calculation of extra-contact-pressure clutch capacities (T_{Üb,kom}^{(AT)}, (T_{Üb,geh}^{(AT)}) of the at least one on-coming and of the at least one off-going clutch in dependence on the basic extra-contact-pressure clutch capacities (T_{Üb,kom}^{(DCT)}, (T_{Üb,geh}^{(DCT)}) and on the effective factors (b^{(i,j)}).
calculation of the clutch capacities (T_{cap}) to be set for the n clutches and of the drive torque (T_{EM}) to be set for the at least one further drive unit in dependence on the load-switching clutch capacities (T_{cap,kom}^{(AT)}, (T_{cap,geh}^{(AT)}) and/or on the load-switching torque (T_{EM}^{(AT)}) of the at least one further drive unit and/or on the extra-contact-pressure clutch capacities (T_{Üb,kom}^{(AT)}, (T_{Üb,geh}^{(AT)}) for the none or at least one on-coming and the none or at least one off-going clutch and/or on the extra-contact-pressure clutch capacities (T_{Üb,blb}) of the none or at least one clutch that remains closed and/or on the cutting torques (T _{cut,blb}) of the m clutches that remain closed and/or on the engagement torque (AΔᵢₙ) of the first and/or of the at least one further drive unit and/or on the at least one engagement torque (ΔT,_{cl}) of the none or at least one on-coming and/or of the none or at least one off-going clutch and/or of the none or at least one clutch that remains closed and/or on the at least one compensating torque (ΔT_{cl,komp}) of the none or at least one on-coming and/or of the none or at least one off-going and/or of the none or at least one open clutch and/or on the compensation torque (ΔT_{EM,komp}) of the at least one further drive unit.

5. The method for load switching of hybridized automatic transmissions according to claim 1, wherein the calculation of the transformation equivalents comprises, alternatively or additionally, the calculation of dual-clutch-transmission-specific maximally settable clutch capacities (T_{cap,geh,max} ^{(DCT)}, (T_{cap,kom,max}^{(DCT)}) in dependence on the maximally transmittable clutch capacities (T_{cap,max}) of the n clutches and/or on the minimally and/or maximally available drive torques (T_{in,min}, T_{in,max}) of the first and/or of the at least one further drive unit, wherein the basic clutch capacities (T_{cap,kom}^{(DCT)}, (T_{cap,geh}^{(DCT)}) for load acceptance during the shifting process for the on-coming and the off-going clutch are additionally determined in dependence on the dual-clutch-transmission-specific maximally settable clutch capacities (T_{cap,geh,max}^{(DCT)}, (T_{cap,kom,max}^{(DCT)}).

6. The method for load switching of hybridized automatic transmissions according to claim 1, wherein the selection of the transformation factors comprises, alternatively or additionally, the selection of a dual-clutch-transmission-specific minimally and/or maximally realizable drive gradient (\dot{ω}ₘᵢₙ^{(DCT)}, \dot{ω}ₘₐₓ^{(DCT)}) or a dual-clutch-transmission-specific minimally and/or maximally realizable drive-gradient change (Δ\dot{ω}ₘᵢₙ^{(DCT)}, Δ\dot{ω}max^{(DCT)}) in dependence on at least one actual variable and/or on the maximally transmittable clutch capacities (T_{cap,max}) of the n clutches and/or on the minimally and/or maximally available drive torque (T_{in,min}, T_{in,max}) of the first and/or of the at least one further drive unit.
